(19) United States
(12) Patent Application Publication
(10) Pub. No.: US 2014/0159404 A1
(43) Pub. Date: Jun. 12, 2014

(54) GRIP AID DEVICE, PARTICULARLY FOR USE WITH STEERING WHEELS, JARS, CANS AND OTHER OBJECTS, AND METHODS OF MAKING AND USING SAME

(71) Applicant: Better Grip LLC, Brooklyn, NY (US)

(72) Inventor: Moustafa Aly, Brooklyn, NY (US)

(73) Assignee: Better Grip LLC, Brooklyn, NY (US)

(21) Appl. No.: 14/101,570

(22) Filed: Dec. 10, 2013

Related U.S. Application Data
(60) Provisional application No. 61/793,829, filed on Mar. 15, 2013.
(60) Provisional application No. 61/735,237, filed on Dec. 10, 2012.

(51) Int. Cl. B25G 1/10; B29C 45/00

(52) U.S. Cl. CPC B25G 1/102; B29C 45/0003
USPC 294/141; 264/255

(57) ABSTRACT

Grip aid devices, and processes of making and using same, are provided. The devices may be sized and shaped such that the devices stretch to fit and take the shape of a standard steering wheel or any steering wheel to which the aid device is being applied. Preferably, the devices are made of a sturdy silicone or rubber to achieve the desired results of preventing the device from slipping off of the steering wheel, of avoiding a cold or hot touch of the steering wheel (i.e., the device is resistant to temperature change(s) or extreme(s)), and of providing a compact, flexible, and versatile device for application to a steering wheel of any type of vehicle. The devices may be used to add a grip to any desired object.

### CROSS-REFERENCE TO RELATED APPLICATION(S)

This application is a non-provisional patent application that claims the benefit of the filing date of, and priority to, U.S. Provisional Application No. 61/735,237, filed Dec. 10, 2012, and U.S. Provisional Application No. 61/793,829, filed Mar. 15, 2013, the entireties of which are incorporated herein by reference.

### BACKGROUND OF THE INVENTION

In general, steering wheels tend to be slippery, and a grip is useful when holding the wheel of a vehicle, particularly to avoid incidents that may result due to interaction with one or more slippery surfaces of the steering wheel. In the vehicle industry, prior attempts to create steering wheel products have been less than ideal. For example, such products are typically made from materials, such as memory foam, leather, etc., that make the steering wheel twice as big in diameter and uncomfortable for a driver of a vehicle. Consequently, such big and bulky products are hard to store when not being used.

Such traditional products also tend to slip off the steering wheel, thereby causing the driver to lose his/her grip while driving, parking in one or more tight spaces, etc.

Additionally, many drivers hesitate to touch the steering wheel in the first place because the steering wheel may be too hot or too cold depending on the environmental conditions in which the vehicle is located or driven. However, when the aforementioned products are left on the steering wheel, these products are insufficient to handle temperature extremes or changes because the products also change, or changed, temperature with the steering wheel such that the products are too hot or too cold as well.

Another problem exists where a hand or both hands of a driver of a vehicle may slip off of the steering wheel for a plurality of reasons, including, but not limited to, sweaty hands, improper steering wheel grips, etc. The aforementioned products fail to solve this problem as the hand or hands of a driver slip off of such products for several reasons, including, but not limited to, due to the materials used to make the products, due to the bulkiness of such products, etc.

It would therefore be desirable to provide an improved steering wheel grip aid device that does not slip off of the steering wheel for avoiding a hand or hands of a user of the device from slipping from a steering wheel, for avoiding the cold or hot touch of the steering wheel, and for providing a compact, flexible, comfortable, and versatile device for application to a steering wheel of any type of vehicle.

### SUMMARY OF THE INVENTION

It is the purpose of the invention to provide an improved steering wheel grip aid device that does not slip off the steering wheel, that avoids a hand or hands of a user of the device from slipping from a steering wheel, that avoids the cold or hot touch of the steering wheel (i.e., is resistant to temperature change(s) or extreme(s)), and that provides a compact, flexible, and versatile device for application to a steering wheel of any type of vehicle.

Surprisingly, the inventor has found that making a steering wheel grip aid device from a silicone or rubber, such as an addition cure silicone elastomer, achieves the desired results. One or more such silicone(s), rubber(s), and addition cure silicone elastomer are preferably high performance cure liquid silicone compounds that are used for a variety of applications ranging from creating skin effects and other movie special effects to making production molds for casting a variety of materials. Since a variety of such silicone(s), rubber(s) and addition cure silicon elastomer(s) are extremely physically sensitive, the superior physical properties and flexibility of one or more of such materials are preferred for making the present invention. Alternatively, other rubber or silicone material may serve the same purpose such that the device may be made from any rubber, silicone or plastic known to those skilled in the art. One or more addition cure silicone elastomers may be purchase from Chengdu TaLy Chemical Industrial Co., Ltd. located at No. 578, South Road 2, Economic and Technological Development Zone, Longquanyi District, Chengdu City, Sichuan Province, 610100, China). Preferably, the rubber or silicone, such as the one or more addition cure silicone elastomers, is non-hazardous. At least one embodiment of the one or more addition cure silicone elastomers may at least one of: (i) include mixtures; (ii) be in liquid physical form; (iii) have color; and (iv) be transparent. In at least one embodiment, the one or more addition cure silicone elastomers have the following components: (i) Poly (dimethylsiloxane) as about 70 percent to about 85 percent thereof; (ii) silicone dioxide as about 15 percent to about 30 percent thereof; and (iii) one or more Platinum catalysts as about 0.01 percent to about 0.1 percent thereof.

Preferably, the grip aid device (also referred to herein as the “Stretchy Grip aid device”, the “Stretchy Grip device” or the “Stretchy Grip steering wheel cover”) is sized and shaped such that the device stretches to fit and take the shape of a standard steering wheel or any steering wheel to which the aid device is being applied. Preferably, the grip aid device comprises at least one of one or more silicones, one or more rubbers and one or more addition cure silicone elastomers as aforementioned.

The grip aid device may include at least a first portion and a second portion having different thicknesses. For example, the first portion of the grip aid device may have a thickness that is double the thickness (e.g., only around the edges of the first portion) of the second portion. To ensure a firm and/or firmer fit to the inner side of the steering wheel, the thicker the portion of the grip aid device contacting the inner side of the steering wheel is, the firmer that portion gets when it is stretched. The portion of the grip aid device contacting the inner side of the steering wheel may have a thickness that is at least one of 2.0 mm and 4.0 mm. Preferably, the first portion of the grip aid device is at least one of: (i) the portion that operates to contact the inner side of the steering wheel cover; (ii) is disposed closer to the center of the steering wheel than the second portion of the grip aid device; and (iii) used as, or defines, one or more edges of the grip aid device. Such use of the first portion of the grip aid device provides one or more edges of the grip aid device with greater strength (as compared to the thinner second portion of the grip aid device) such that the grip aid device operates to reduce, minimize and/or eliminate ripping or tearing from use over time (e.g., when placed on and/or removed from the steering wheel repeatedly).

In at least one embodiment, a grip aid device for gripping a predetermined item, may include a band including at least two portions, the at least two portions including a first portion and a second portion adjacent to and connected to each other, wherein the first portion and the second portion have different amounts of at least one of: stretchiness, flexibility and elasticity. The band may operate to at least one of: (i) absorb and release heat to keep a predetermined item warm on, and/or adjacent to, which the band is disposed while retaining its at least one of: stretchiness, flexibility and elasticity; (ii) be resistant to at least one of extreme temperature(s) and temperature change(s) such that the band helps at least one of: provide a warmer, softer surface on the predetermined item to touch and/or grip and provide a cooler surface on the predetermined item to touch and/or grip; (iii) return to at least one of: its original temperature at which the band was before the temperature change, room temperature, a temperature substantially near room temperature, a temperature substantially between an extreme cold temperature and an extreme hot temperature, and a predetermined temperature; (iv) absorb ambient temperature or ambient heat; (v) provide a better grip on the predetermined item such that one or more hands of a user of the grip aid device does not slip off of the predetermined item or the grip aid device; (vi) protect the user of the grip aid device from the extreme temperatures and the temperature changes; (vii) the predetermined item is at least one of: a steering wheel, a jar, a can, a garbage bag, a garbage can, a garbage can and a garbage bag disposed in the garbage can, a shopping cart, a driving instrument, a table, one or more equipment items, a game controller, a forklift, a pot, a flower pot, and the abdomen or the lower back of a user of the grip aid device; (viii) be preheated or heated to a predetermined temperature prior to being applied to, disposed on and/or adjacent to the predetermined item such that the grip aid device operates to at least one of: provide the user with a warm, comfortable grip or feeling for a predetermined amount of time and/or until the temperature of the predetermined item rises to a predetermined level; protect the user from a cold environment in which the predetermined item was located; and protect the user from the cold temperature of the predetermined item; (ix) take the shape of the predetermined item on which and/or adjacent to which it is disposed or applied; and (x) operate as a steering wheel cover when the predetermined item is a steering wheel.

The band may include at least one of plastic, rubber, silicone; addition cure silicone elastomer; a sturdy rubber, a sturdy silicone and a sturdy addition cure silicone elastomer. The band may be sized and shaped to correspond to, and comply with, one or more dimensions of the predetermined item, thereby operating to at least one of: support and secure itself around the predetermined item, provide a grip for the predetermined item, avoid slipping off of the predetermined item, prevent a hand or hands of a user of the device from slipping off of or from the predetermined item, protect the user from the predetermined item when the predetermined item is hot or cold, and grip the predetermined item with about 90% efficiency such that about 90% of the grip aid device is firmly grasping or gripping the predetermined item. The band may be substantially 0-shaped or substantially 0-shaped. The band may further include a connecting device for at least one of: holding two ends of the band together and holding the first and second portion together. The band may operate to fold and/or bend for easy storage. The band may not include at least one of: string, lace, stitching, an elastic stitch, glue, a bungee cord, Velcro tape, and one or more snaps. Preferably, the band has at least four surfaces, the at least four surfaces including a first surface, a second surface, a third surface and a fourth surface, the first and second surfaces being substantially parallel to each other, the third and fourth surfaces being substantially parallel to each other and the third and fourth surfaces extending between the first and second surfaces.

The band may have a substantially consistent width along the length of the band. The band may have a width that is at least one of: about 2 inches, about 95.0 millimeters (“mm”), about 85.0 mm, about 66.0 mm, about 94.0 mm, about 91.0 mm to about 97.0 mm, about 90.0 mm, about 1¼ inches, about 1½ inches, about 1¾ inches, about 2 inches, about 2¼ inches, about 2½ inches, and about 2¾ inches. The band may have a length that is at least one of: about 14 inches and about 222.25 mm, and may have a thickness that is at least one of: about 2 mm to about 3 mm, about 4 mm to about 5 mm, about 2 mm to about 4 mm, about 3 mm to about 5 mm, about 3.8 mm and about 2 mm to about 5 mm. The band may have a diameter that is at least one of: about 10 inches, about 220.0 mm, about 225.25 mm, about 216 mm, about 211 mm to about 221 mm, about 215 mm, about 14½ inches to about 15½ inches, and about 10 inches to about 12 inches, about 10½ inches, about 11 inches, about 11½ inches, about 12 inches, about 12½ inches, between about 10 inches and about 12½ inches, between about 10 inches and about 10½ inches, between about 10 inches and about 11 inches, between about 10 inches and about 11½ inches, between about 10 inches and about 12 inches, between about 10½ inches and about 11 inches, between about 10½ inches and about 11½ inches, between about 10½ inches and about 12 inches, between about 10½ inches and about 12½ inches, between about 11 inches and about 11½ inches, between about 11 inches and about 12 inches, between about 11 inches and about 12½ inches, and between about 12 inches and about 12½ inches.

In at least one embodiment, the first and section portions of the band may include at least one of: plastic, rubber, silicone; addition cure silicone elastomer; a sturdy rubber, a sturdy silicone and a sturdy addition cure silicone elastomer. The first and second portions, and/or portions thereof, may be at least one of co-linear, substantially co-linear, co-planar, substantially co-planar, co-axial and substantially co-axial. The first portion may have at least one of: about 5% less stretch than the second portion, about 10% less stretch than the second portion, about 15% less stretch than the second portion, about 20% less stretch than the second portion, about 15% to about 20% less stretch than the second portion, and about 5% to about 20% less stretch than the second portion. The first portion may be melded, merged, fused, melted, and/or blended together with the second portion. Additionally or alternatively, the first and second portions may be integral. The first side of the band may include a first surface of the first portion and a first surface of the second portion, the second side of the band may include a second surface of the first portion and a second surface of the second portion, the third side of the band may include a first side of the first portion, and the fourth side of the band may include a first side of the second portion, the second portion having a second side and the first portion having a second side that is located adjacent to, and/or connected to, the second side of the second portion. The first portion and the second portion may have different textures and/or strengths, thereby resulting in the first and second portions having the different amounts of at least one of: stretchiness, flexibility and elasticity. The first portion may be disposed at, or define, a first edge of the band. The first portion and the second portion may have different thicknesses, thereby resulting in the first and second portions having the different amounts of at least one of: stretchiness, flexibility and elasticity, or the thicknesses of the first portion and the second portion may be substantially the same or are the same while the first and second portions have the different amounts of at least one of: stretchiness, flexibility and elasticity. When the thickness of the first and second portions are not the same, the difference in thickness between the first portion and the second portion may define a rim or curved edge that operates to at least one of improve the grip of, and secure the band onto, the predetermined item. The first portion may be thicker than the second portion, thereby resulting in the first and second portion having the different amounts of at least one of: stretchiness, flexibility and elasticity. The thickness of the first portion may at least one of taper and increase gradually over the width of the first portion as the first portion extends away from the second portion.

While not being limited by the dimensions discussed herein, the first portion and the second portion may have various types of dimensions. For example, the first portion may have a width that is at least one of: about 10.0 mm, about 12.0 mm, about 8.6 mm, about 12.5 mm, about 9.5 mm to about 15.5 mm, and about 6 mm. The (ii) the first portion has a thickness that is at least one of: about 2.0 mm, about 4.0 mm, about 4.5 mm, about 4.0 mm to about 4.5 mm, about 4.2 mm, about 4 mm to about 4.4 mm, about 9.0 mm, about double the thickness of the second portion, and about double the thickness of any portion of the band. The second portion may have a width that is at least one of: about 42.0 mm; about 72.0 mm, about 81.5 mm, about 84.5 mm, about 78.5 mm, about 78.5 mm to about 84.5 mm, about 75.5 mm, about 87.5 mm, about 75.5 mm to about 87.5 mm, about 75 mm, about 86.4 mm, and about 72 mm to about 90 mm. The second portion may have a thickness that is at least one of: about 2.0 mm, substantially about 2.0 mm, about 3.0 mm, about 2.8 mm to about 3.2 mm, about 4.0 mm, about 4.5 mm, about 4.0 to about 4.5 mm, about half the thickness of the first portion, and about half the thickness of any portion of the band.

In at least one embodiment, the band may further include a third portion adjacent to and connected to the second portion such that the second portion is disposed between the first and third portions, and maybe at least one of: (i) the first side of the band may include a first surface of the first portion, a first surface of the second portion and a first surface of the third portion; the second side of the band comprises a second surface of the first portion, a second surface of the second portion and a second surface of the third portion, the third side of the band comprises a first side of the first portion, and the fourth side of the band comprises a first side of the third portion, the second portion having a first side and a second side, the first portion having a second side that is located adjacent to, and/or connected to, the first side of the second portion and the third portion having a second side that is located adjacent to, and/or connected to, the second side of the second portion; (ii) the third portion may be disposed at or defines a second edge of the band; (iii) the first and third portions may be on opposite sides of the band, thereby defining opposite edges of the band; (iv) the third portion and the second portion may have different textures and/or strengths, thereby resulting in the third and second portion having the different amounts of at least one of: stretchiness, flexibility and elasticity; (v) the third portion may include at least one of: plastic, rubber, silicone; addition cure silicone elastomer; a sturdy rubber, a sturdy silicone and a sturdy addition cure silicone elastomer; (vi) the third portion and the second portion may have different thicknesses, thereby resulting in the first and second portion having the different amounts of at least one of: stretchiness, flexibility and elasticity, or the third portion and the second portion may have the same or substantially the same thicknesses while the third and second portions have the different amounts of at least one of: stretchiness, flexibility and elasticity; (vii) the third portion and the first portion may have different thicknesses, thereby resulting in the third and first portions having different amounts of at least one of: stretchiness, flexibility and elasticity, or the third and first portions may have the same or substantially the same thicknesses while the third and first portions have the different amounts of at least one of: stretchiness, flexibility and elasticity; (viii) the third portion and the first portion may have substantially the same or the same thicknesses, textures and/or strengths while the third and the first portions have the same amount of at least one of: stretchiness, flexibility and elasticity; (ix) at least one of: the second portion may have more at least one of stretchiness, flexibility and elasticity than the first portion and the third portion, and the third and first portions may be at least one of harder and firmer than the second portion; (x) the third portion may have at least one of: about 5% less stretch than the second portion, about 10% less stretch than the second portion, about 15% less stretch than the second portion, about 20% less stretch than the second portion, and about 15% to about 20% less stretch than the second portion; (xi) the third portion may be integral with the second portion and the first portion; (xii) the third portion may be melded, merged, fused, melted, and/or blended together with the second portion; (xiii) the second and third portions may be at least one of co-linear, substantially co-linear, co-planar, substantially co-planar, co-axial and substantially co-axial; (xiv) the third portion may be thicker than the second portion, thereby resulting in the third and second portions having the different amounts of at least one of: stretchiness, flexibility and elasticity; (xv) when the third and second portions have different thicknesses, the difference in thickness between the third portion and the second portion may define a rim or curved edge that operates to at least one of improve the grip of and secure the band onto the predetermined item; and (xvi) the thickness of the third portion may at least one of taper and increase gradually over the width of the third portion as the third portion extends away from the second portion.

The third portion may have a width that is at least one of: about 10.0 mm, about 12.0 mm, about 8.6 mm, about 12.5 mm, about 9.5 mm to about 15.5 mm, and about 6 mm, and may have a thickness that is at least one of: about 2.0 mm, about 4.0 mm, about 4.5 mm, about 4.0 mm to about 4.5 mm, about 4.2 mm, about 4 mm to about 4.4 mm, about 9.0 mm, about double the thickness of the second portion, and about double the thickness of any portion of the band.

At least one of the first and third portions may include one or more structural features that operate to permit greater stretch or flex of the band as compared to the band not using the one or more structural features. The one or more structural features may include at least one of: one or more sloped surfaces, one or more tapered surfaces, one or more chamfered surfaces, one or more curved surfaces, one or more smooth surfaces, and one or more recesses or grooves. At least one of the first and third portions may be about 1.9 mm in width at its narrowest location when including the one or more structural features. The one or more tapered surfaces, the one or more chamfered surfaces and the one or more angled surfaces may have a 15 degree angle with respect to the surface of the band. At least one of the first and third portions may include a curved end disposed adjacent to the second portion such that the band provides a comfortable grip and operates to at least one of stretch and flex up to 50% of the size of the band when the band is not being at least one of stretched and flexed. At least one of the first and third portions may differ from each other in at least one of length, width and thickness to permit greater stretch or flex of the band. At least one of the first portion and the third portion may include an edge, the edge having a thickness larger than the thickness of the second portion; and the edge of at least the one of the first portion and the third portion may include the one or more structural features.

At least one of the first portion and the third portion may further include a first section and a second section where the first section may have a thickness that increases over the width thereof and the second section may have a thickness that remains constant or substantially constant over the width thereof. The first section may have the same or substantially the same thickness as the second portion along the length of the first section that is adjacent to, and contacts or connects with, the second portion, and the thickness of the first section may at least one of increase and taper as the first section extends away from the second portion of the band. The second section may have a thickness that is the same or substantially the same as at least one of the thickest part of the first section and the portion of the first section that is adjacent to, and contacts or connects with, the second section. The first section may have a width that is at least one of: about 5.16 mm and about 2.16 mm to about 8.16 mm, and the second section may have a width that is at least one of: about 7.34 mm and about 4.34 mm to about 10.34 mm. The diameter from the curved end on one side of the grip aid device to the curved end on the other side of the grip aid device may be at least one of: about 195 mm, about 190.5 mm, and about 190 mm to about 195 mm.

Additionally or alternatively, a portion of the band may further include liquid rubber or liquid silicone, and the liquid rubber or liquid silicone may operate to be thinned or thickened with rubber or silicone thinner or with rubber or silicone thickener, respectively. One or more portions of the band may cure at about 73 degrees Fahrenheit or 23 degrees Celsius with negligible to no shrinkage.

A grip aid device (or steering wheel cover) in accordance with one or more aspects of the present invention may be etched or may have designs and/or messages included thereon. Indeed, those skilled in the art will recognize that users can supplement the look of the grip aid device with attached designs, such as, but not limited to, different textures, text, designs, graphical designs, colors, patterns, different widths, attached embellishments, finishes, appliqués, etc. For example, the band may include at least one of one or more etchings, one or more designs and one or more messages, and the at least one of one or more etchings, one or more designs and one or more messages may include at least one of: one or more different textures, text, one or more graphical designs, one or more colors, one or more patterns, one or more different widths, one or more attached embellishments, one or more finishes, and one or more appliqués. At least one of the plastic, the rubber, the silicone, the addition cure silicone elastomer, the sturdy rubber, the sturdy silicone and the sturdy addition cure silicone elastomer of the band may be transparent or translucent such that the at least one of the one or more etchings, the one or more designs and the one or more messages of the band may be viewable through the material of the band. The band may operate to glow in the dark or low light; and the band may include one or more fragrances such that the grip aid device operates as an air freshener.

When the predetermined item has a first edge and a second edge, the first edge being disposed or located closer to the center of the predetermined item as compared to the second edge of the predetermined item located or disposed further away from the center of the predetermined item, at least one of the following may occur: (a) at least one of the first portion and the third portion of the grip aid device may operate to at least one of: (i) grip the first edge; (ii) grip a predetermined circumference or line that is closer to the center of the predetermined item than another predetermined circumference or line of the predetermined item; and (iii) grip a first side of the predetermined item; and (b) the second portion of the grip aid device may operate to at least one of: (i) grip the second edge; (ii) grip the other predetermined circumference or line; and (iii) grip a second side of the predetermined item, the second side being located on the opposite side of the predetermined item from the first side.

In accordance with at least another aspect of the present invention, one or more methods of making a grip aid device are provided, which may include: (i) providing a mold including at least two injection ports disposed at predetermined positions in the mold; (ii) injecting a predetermined amount of at least one of a first rubber, a first plastic and a first silicone into the mold in the first injection port of the at least two injection ports of the mold; (iii) mounting the mold on a vulcanizer heated to a predetermined temperature; (iv) waiting for a predetermined amount of time until the at least one of the first rubber, the first plastic and the first silicone in the mold is about half vulcanized or is semi-cured; (v) injecting a predetermined amount of at least one of a second rubber, a second plastic and a second silicone into the mold in the second injection port of the at least two injection ports of the mold; and (vi) removing the grip aid device from the mold once the at least one of the first rubber, the first plastic and the first silicone and the at least one of the second rubber, the second plastic and the second silicone have adhered to each other, thereby forming the grip aid device. The method may further include at least one of: (i) the at least one of the first rubber, the first plastic and the first silicone and the at least one of the second rubber, the second plastic and the second silicone are the same type or composition of material or are different types or compositions of material; (ii) the at least one of the first rubber, the first plastic and the first silicone flows into a mid-stream level in the mold; (iii) the at least one of the second rubber, the second plastic and the second silicone flows into its predetermined mold level; (iv) both injection steps occur at the same time in a single injection process; (v) the injection steps occur at different times in a double injection process; (vi) the predetermined temperature is at least one of: 120 degrees Fahrenheit, 120 degrees Celsius and a temperature corresponding to the weight of the at least one of the rubber, plastic and silicone being molded; (vii) the predetermined amount of time is about five minutes; (viii) the at least one of the first rubber, the first plastic and the first silicone in the mold is about half vulcanized or is semi-cured when the at least one of the first rubber, the first plastic and the first silicone in the mold is no longer liquid; and (ix) the at least two injection ports comprise two injection ports. The at least two injection ports may be disposed at predetermined positions in the mold comprise three injection ports.

The one or more methods may further include at least one of: (i) waiting for the predetermined amount of time until the at least one of the first rubber, the first plastic and the first silicone is fully cured, and the at least one of the second rubber, the second plastic and the second silicone is semi-vulcanized and, due to a common curing process, the at least one of the first rubber, the first plastic and the first silicone and the at least one of the second rubber, the second plastic and the second silicone have been firmly bonded together; (ii) injecting a predetermined amount of at least one of a third rubber, a third plastic and a third silicone into the mold in the third injection port of the three injection ports of the mold; (iii) waiting for a second predetermined amount of time until the curing of the at least one of the first rubber, the first plastic and the first silicone, the at least one of the second rubber, the second plastic and the second silicone and the at least one of the third rubber, the third plastic and the third silicone is complete; and (iv) removing the grip aid device from the mold once the at least one of the first rubber, the first plastic and the first silicone, the at least one of the second rubber, the second plastic and the second silicone and the at least one of the third rubber, the third plastic and the third silicone have adhered to each other, thereby forming the grip aid device. The injection ports may be cut off from the grip aid device. The at least one of the first rubber, the first plastic and the first silicone, the at least one of the second rubber, the second plastic and the second silicone and the at least one of the third rubber, the third plastic and the third silicone may be the same type or composition of material or may be different types or compositions of materials. The predetermined levels for each of the at least one of the first rubber, the first plastic and the first silicone, the at least one of the second rubber, the second plastic and the second silicone and the at least one of the third rubber, the third plastic and the third silicone may be the same or different. The at least one of the first rubber, the first plastic and the first silicone and the at least one of the third rubber, the third plastic and the third silicone may be the same type or composition of material, and the at least one of the second rubber, the second plastic and the second silicone may be a different type or composition of material. The three injection ports may be disposed at predetermined, corresponding positions along the length of the mold. The second predetermined amount of time may be about 10 minutes.

One or more methods of making a grip aid device in accordance with one or more aspects of the present invention may further include at least one of: (i) using a round or substantially round mold with a thickness of approximately 4 mm in thickness and about 10 inches in diameter; (ii) using a circular or round pan to achieve the desired round shape so the mold, which is made out of a silicone, plastic or rubber material, operates to be poured inside the circle of the circular or round pan and around it; (iii) leaving the mold to dry for about 12 hours; (iv) removing the circular or round pan after the mold is dry, thereby leaving the space empty to pour the first, second and/or third at least one of the rubber, the plastic and the silicone material into the circular or round pan; (v) leaving the first, second and/or third at least one of the rubber, the plastic and the silicone material to dry for about 12 hours; (vi) removing the mold after the first, second and/or third at least one of the rubber, the plastic and the silicone material is dry, thereby getting a substantially round grip aid device; (vii) using vacuum degassing to minimize and/or reduce air bubbles in the cured grip aid device; (viii) using a liquid rubber or liquid silicone as one of the first, second and/or third at least one of the rubber, the plastic and the silicone material; (ix) thinning or thickening the liquid rubber or liquid silicone with a rubber or silicone thinner or with a rubber or silicone thickener, respectively; and (x) curing one or more portions of the grip aid device at about 73 degrees Fahrenheit or 23 degrees Celsius such that the grip aid device has negligible to no shrinkage. The one or more methods may further include using gravity to have the at least one of the first rubber, the first plastic and the first silicone and the at least one of the second rubber, the second plastic and the second silicone flow into predetermined first and second mold levels, respectively, in the mold.

Additionally, new and improved methods of using the grip aid device are disclosed herein. In accordance with at least one aspect of the invention, the grip aid device may be preheated and then applied to the predetermined item (e.g., a steering wheel, a jar, a can, etc.). Preferably, the preheated grip aid is heated to a predetermined temperature such that the preheated grip aid operates to at least one of: provide the user with a warm, comfortable grip or feeling for a predetermined amount of time (e.g., 10 minutes, 15 minutes, etc.); protect the user from a cold, harsh environment in which the predetermined item was located (e.g., the predetermined item may be cold, the predetermined item may be as cold as the cold, harsh environment, etc.); and protect the user from the cold temperature of the predetermined item (e.g., after the predetermined item was located in a cold, harsh environment for a predetermined amount of time). A predetermined heating source (e.g., a microwave, boiling water, a fireplace, etc.) may be used to pre-heat the grip aid device.

For example, by placing the grip aid device (e.g., a grip aid device of the invention including one or more silicones (such as one or more addition cure silicone elastomers) one or more plastics, one or more rubbers, etc.) in the microwave for a couple of minutes, the grip aid device including the one or more addition cure silicone elastomers will absorb the heat and will remain warm for about 10-about 15 minutes. Thereafter, the grip aid device may then operate to slowly release the heat in a predetermined object, such as a steering wheel of a car. As such, the heated grip aid device may operate to heat the predetermined object on which the grip aid device is disposed.

Additionally or alternatively, a user of the grip aid device may place the grip aid device on the steering wheel while the grip aid device is warm, and the heat in the vehicle may maintain the temperature of, or provide heat to, the grip aid device, thereby providing a nice, warm, and toasty or comfy state or environment for the grip aid device. In one or more embodiments, the Stretchy Grip grip aid device (e.g., when including the addition cure silicone elastomer) may operate to absorb the heat from, or release heat to, an interior portion (e.g., the cabin) of the vehicle within a couple of minutes, e.g., 1-2 minutes, 1-3 minutes, 1-5 minutes, 5-10 minutes, etc. Additionally, the grip aid device operates to act as an indirect heat exchanger to absorb the heat from the environment and to transfer that heat to the predetermined item on which it is disposed, such as the steering wheel.

Preferably, the addition cure silicone elastomer (also referred to as “silicone elastomer”) includes non hazardous chemicals (e.g., the silicone elastomer may be modified or provided to meet any relevant state or country laws and/or regulations). The silicone elastomer may include a mixture of chemicals, and may be provided in liquid physical form. The silicone elastomer may be colored in one or more embodiments. Alternatively, the silicone elastomer may not be colored.

The silicone elastomer may be used to make exceptionally strong and/or tear resistant molds for casting plaster, wax, concrete, resins, and other materials. Indeed, such silicones or rubbers may be time tested, versatile special effects materials. In one or more embodiments, the silicone elastomer is preferably soft, super strong and stretchy. For example, the addition cure silicone elastomer may have different textures and strengths depending on any predetermined use for the silicone elastomer. Preferably, the silicone elastomer of the grip aid device is designed to meet the needs of the user, and is sized and shaped to correspond to, and comply with, the one or more dimensions of at least one steering wheel of a user. The needs of the user may vary from user to user, and/or the one or more dimensions may vary from steering wheel to steering wheel.

Other objects of the invention will in part be understandable and will in part be apparent from the following description.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown. To assist those of ordinary skill in the relevant art in making and using the subject matter hereof, reference is made to the appended drawings and figures, wherein:

FIG. 1 is a perspective view of at least one embodiment of a grip aid device in accordance with at least one aspect of the present invention.

FIG. 2 is a perspective view of a grip aid device in accordance with at least one aspect of the present invention.

FIG. 3 is a side view of a grip aid device in accordance with at least one aspect of the present invention.

FIG. 4 is a cross-section view of the grip aid device of FIG. 3 taken along line A-A as shown in FIG. 3 in accordance with at least one aspect of the present invention.

FIG. 5 is a schematic view of at least an additional grip aid device in accordance with at least one aspect of the present invention.

FIG. 6 is a side view of at least another grip aid device including two portions thereof having different thicknesses in accordance with at least one aspect of the present invention.

FIG. 7A is a cross-section view of the grip aid device of FIG. 6 taken along line A-A as shown in FIG. 6 in accordance with at least one aspect of the present invention.

FIG. 7B is a cross-sectional view of a grip aid device having different dimensions than the steering wheel grip aid device of FIG. 6 but taken along a line (e.g., similar to line A-A as shown in FIG. 6) having the thicker of the two portions including two sections where the thickness in the first section increases as the thicker of the two portions extends away from the thinner of the two portions and where the thickness in the second section remains constant in accordance with at least one aspect of the present invention.

FIG. 7C is a magnified view of a portion of the cross-sectional view of FIG. 7B shown in the circle at the bottom left of FIG. 7B in accordance with at least one aspect of the present invention.

FIG. 8A is a schematic view of at least a portion of an additional grip aid device including two portions thereof having different thicknesses where the thickness of the second portion increases as the second portion extends away from the first portion in accordance with at least one aspect of the present invention.

FIG. 8B is a perspective view of a grip aid device in accordance with the schematic of FIG. 8A in accordance with at least one aspect of the present invention.

FIG. 9A is a side view of at least another grip aid device including three portions thereof where the first and third portions are thicker than the second portion and the first and third portions include a curved section in accordance with at least one aspect of the present invention.

FIG. 9B is a cross-sectional view of the aid device of FIG. 9A taken along line A-A as shown in FIG. 9A in accordance with at least one aspect of the present invention.

FIG. 9C is a perspective view of a grip aid device including translucent or transparent silicone or rubber material in accordance with at least one aspect of the present invention.

FIG. 9D is a schematic view of a grip aid device in accordance with at least one aspect of the present invention.

FIG. 9E is a perspective view of the grip aid device of FIG. 9D in accordance with at least one aspect of the present invention.

FIG. 10 is a schematic view of yet another grip aid device including three portions thereof where the first and third portions include a tapered, angled or chamfered surface in accordance with at least one aspect of the present invention.

FIG. 11A is a perspective view of a user of a grip aid device operating as a steering wheel cover, the user holding the device against a steering wheel for application of the device to the steering wheel in accordance with at least one aspect of the present invention.

FIG. 11B is a perspective view of the user of FIG. 11A applying the steering wheel grip aid device to a steering wheel in accordance with at least one aspect of the present invention.

FIG. 11C is a perspective view of the user of FIG. 11A applying the steering wheel grip aid device to a steering wheel in accordance with at least one aspect of the present invention.

FIG. 11D is a perspective view of the steering wheel grip aid device of FIGS. 11A-11C installed on a steering wheel in accordance with at least one aspect of the present invention.

FIG. 12A is a perspective view of a steering wheel grip aid device having one or more designs on the device and as installed on a steering wheel in accordance with at least one aspect of the present invention.

FIG. 12B is a front view of the steering wheel grip aid device shown in FIG. 12A as installed on a steering wheel in accordance with at least one aspect of the present invention.

FIG. 13 is a front view of an additional steering wheel grip aid device where the grip aid device stretches over, covers, and tightly grips a larger surface area of a steering wheel than the grip aid device of FIG. 12B.

FIG. 14 is a flow chart of at least one embodiment of a method of making one or more grip aid devices in accordance with one or more aspects of the present invention.

### DETAILED DESCRIPTION OF THE PRESENT INVENTION

A steering wheel grip aid device that does not slip off of a predetermined item, such as a steering wheel, and methods of making and using same are disclosed herein for preventing a hand or hands of a user of the device from slipping from a steering wheel, for providing a tight grip on the predetermined item, for avoiding a cold or hot touch of the steering wheel (i.e., is resistant to temperature change(s) or extreme(s)), and for providing a compact, flexible, and versatile device for application to a steering wheel of any type of vehicle. Preferably, the grip aid device is sized and shaped such that the device stretches to fit and take the shape of a standard steering wheel or any steering wheel to which the aid device is being applied.

Surprisingly, it has been found that making a steering wheel grip aid device from a sturdy silicone or rubber or an addition cure silicone elastomer achieves the desired results. The silicone elastomer may be used to make exceptionally strong and/or tear resistant molds for casting plaster, wax, concrete, resins, and other materials. Indeed, such silicones or rubbers may be time tested, versatile special effects materials. In one or more embodiments, the silicone elastomer is preferably soft, super strong and stretchy. For example, the addition cure silicone elastomer may have different textures and strengths depending on any predetermined use for the silicone elastomer. Preferably, the silicone elastomer of the grip aid device is designed to meet the needs of the user, and is sized and shaped to correspond to, and comply with, the one or more dimensions of at least one steering wheel of a user. The needs of the user may vary from user to user, and/or the one or more dimensions may vary from steering wheel to steering wheel. While addition cure silicone elastomers are preferred for making the present invention, other rubber or silicone material may be employed for the device 1 such that the device 1 may be made from any rubber, silicone or plastic known to those skilled in the art. Preferably, the rubber, silicone or plastic used for the device 1 possesses the one or more structural attributes such that the device 1 at least one of: does not slip off of the steering wheel, operates to prevent a hand or hands of a user of the device 1 from slipping off of or from the steering wheel, avoids a cold or hot touch of the steering wheel (i.e., the device 1 is resistant to temperature change(s) or extreme(s)), and provides a compact, flexible, and versatile device for application to a steering wheel of any type of vehicle.

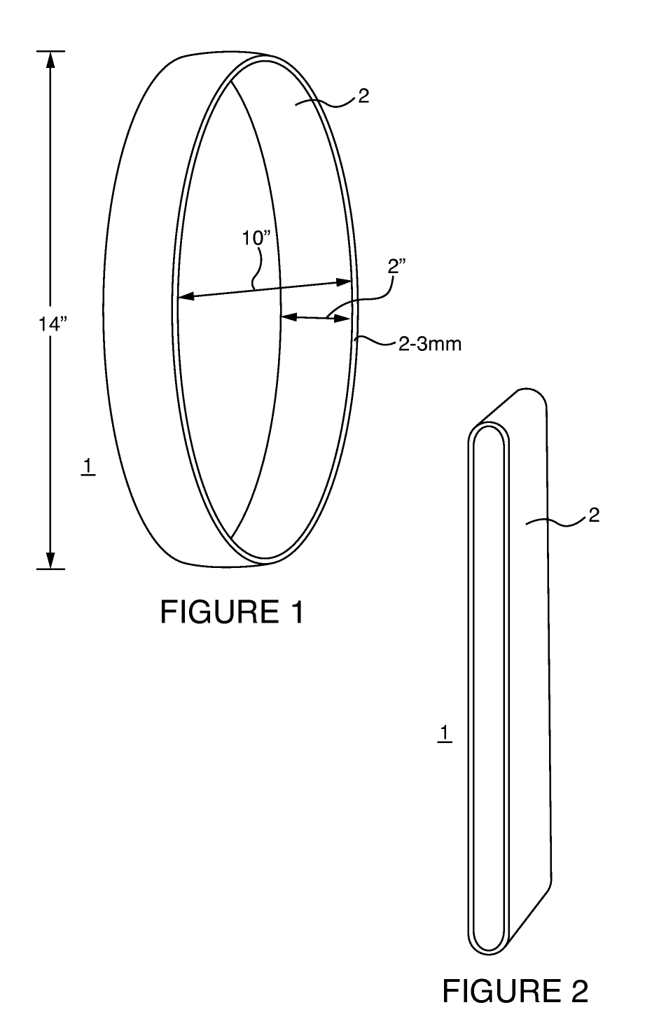

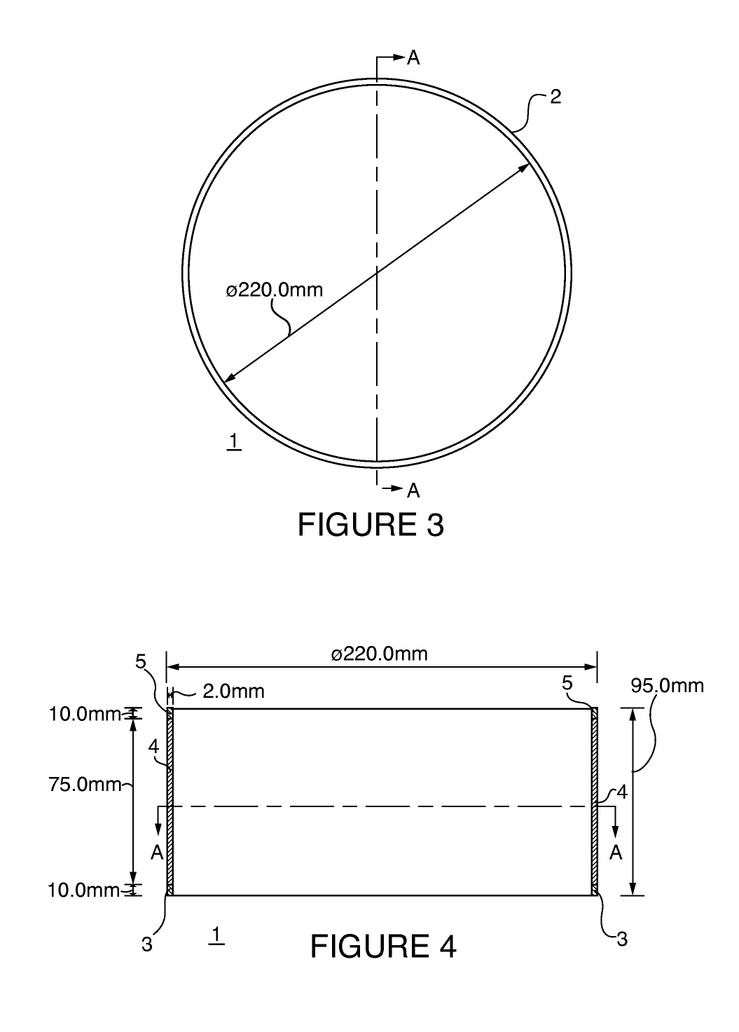

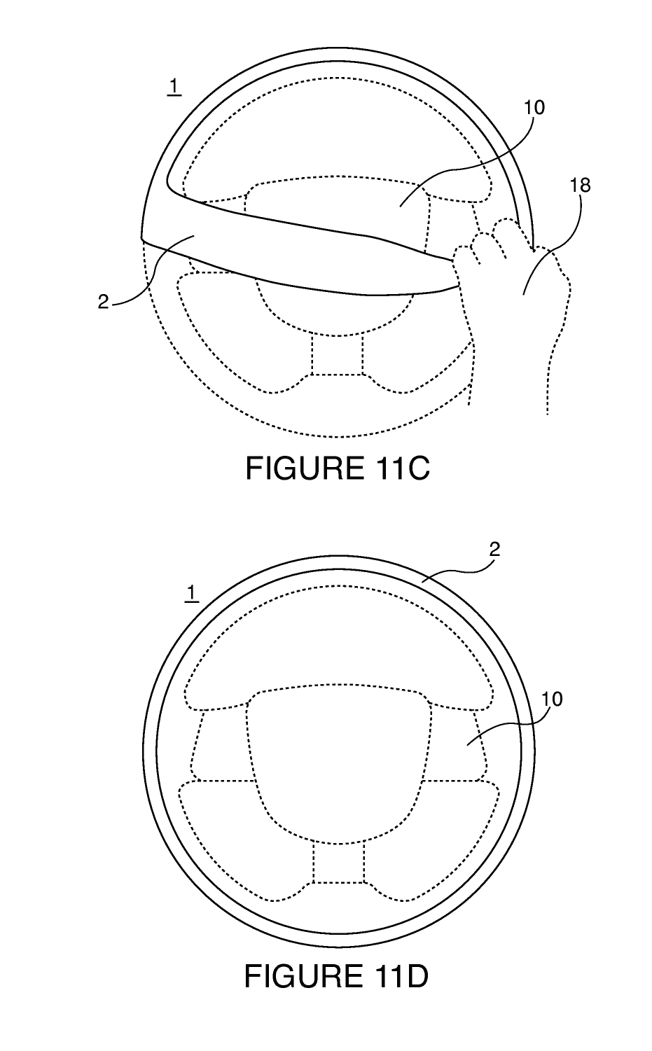

As best seen in FIGS. 1-2, in accordance with a broad aspect of the present invention, a band 2 of the steering wheel grip aid device 1 operates to support and/or secure itself around a steering wheel of a vehicle to provide sufficient grip to a user of the device, i.e., the driver of the vehicle. Preferably, the device 1 is substantially O-shaped and is made from the sturdy silicone or rubber and/or addition cure silicone elastomer to provide a secure fit that clings well to one or more steering wheels. The band 2 may be injection molded to make the device 1. Preferably, the band 2 is stretchable, flexible, and/or elastic such that the band 2 operates to fit the needs of the user and the dimension of the steering wheel of a user, which may vary from user to user and wheel to wheel. The silicone or rubber material, including, but not limited to, addition cure silicone elastomer, used for the band 2 may be as soft as needed to give the device 1 the desired flexibility, stretch, and/or elasticity while maintaining grip support for the user. In some embodiments, the width of the band 2 may vary over the length of band 2 for proper fit on a steering wheel. As best seen in FIGS. 1-2, preferably, the width of the band 2 is substantially consistent along the entire length of the device 1. Preferably, the band 2 is one integral piece that is continuous all the way around (best seen in FIGS. 1-2). However, in at least one embodiment, the band 2 may include a connecting device for holding two ends of the band 2 together. In accordance with at least one embodiment, the band 2 of the device 1 may be comprised of different lengths and widths. In at least one embodiment (best seen in FIG. 1), the band 2 of the device 1 may be 2 inches wide, 2 to 3 millimeters thick, and may have a length of 14 inches and a diameter of 10 inches. The band 2 of the device 1 may be in the shape of a flat, round rubber band (best seen in FIGS. 1-2). Unlike other steering wheel covers that take too much time to apply to a steering wheel, cannot be easily removed from a steering wheel and cannot be easily stored because they are bulky, one or more embodiments of the present invention may fold and bend for easy storage (packing, carrying, vacationing, etc.) and may only take seconds (e.g., less than a minute, about a minute or two minutes, less than 30 seconds, less than 45 seconds, etc.) to slip on and slip off of a steering wheel or other predetermined item. For example, as best seen in FIGS. 11A-13 (further discussed below), the band 2 of one or more devices 1 may be easily stretched to apply the one or more devices 1 onto a steering wheel 10. The Stretchy Grip product, such as the device 1, preferably has no string or lace to fit on the wheel 10, and stretches to fit thereon.

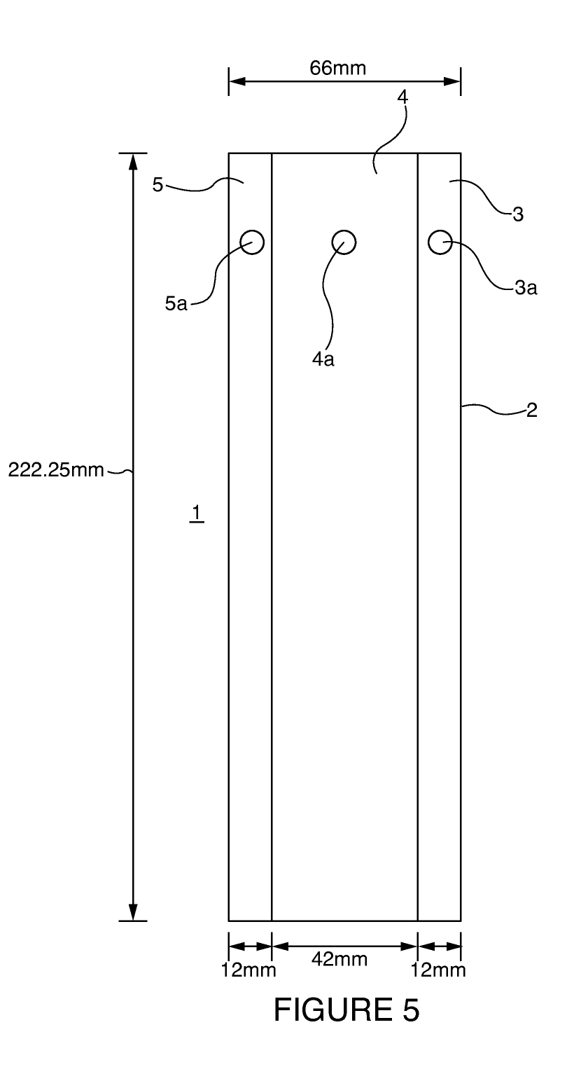

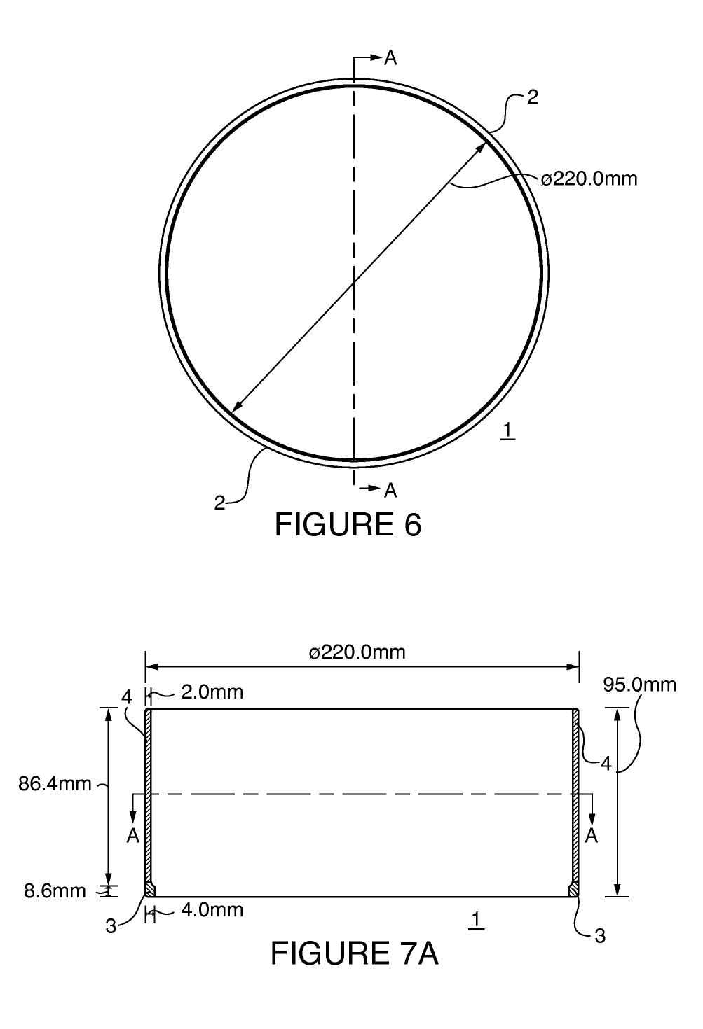

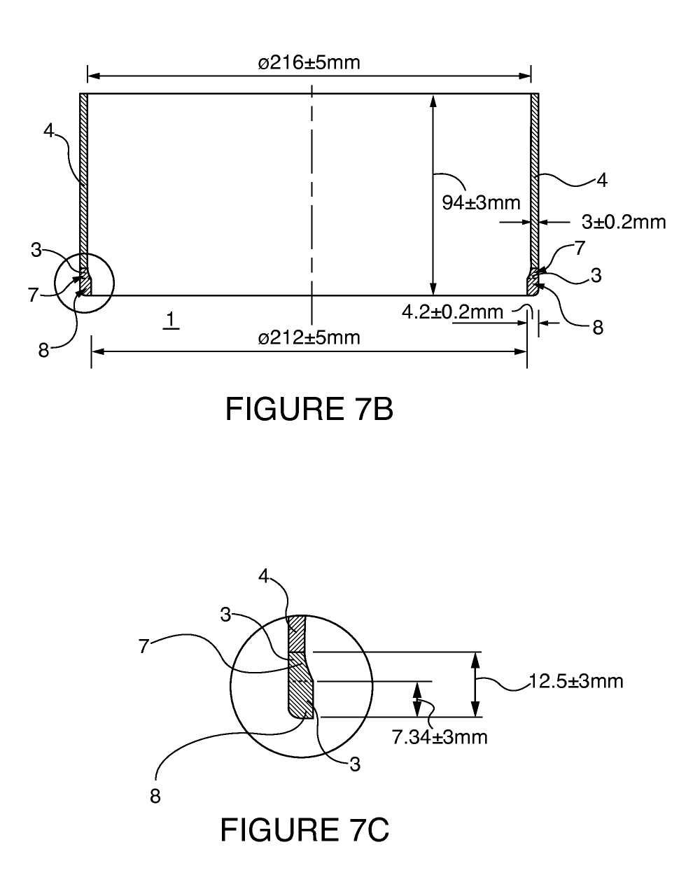

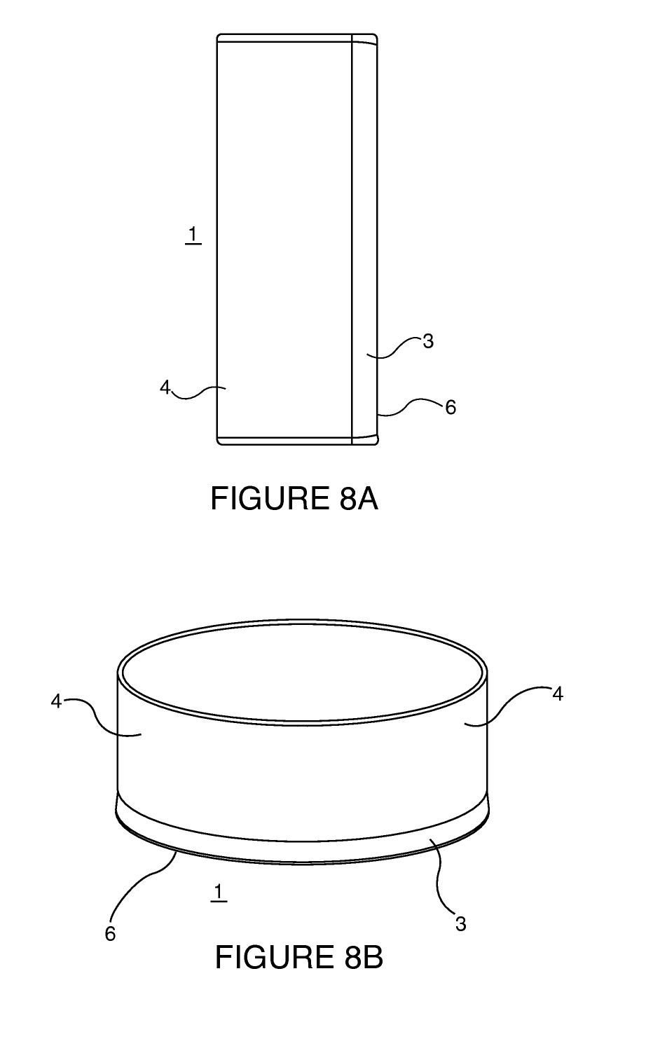

In one or more embodiments, the Stretchy Grip grip aid device 1 material (e.g., rubber or silicone, such as Addition cure silicone elastomer) used for the band 2 may be as soft as needed to give the device 1 the desired flexibility, stretch, and/or elasticity while maintaining grip support for the user. In one or more embodiments, different textures, different thicknesses, different portions having different amounts of stretch (i.e., a portion having a different stretch than another portion of the band 2) of silicone, rubber or plastic may be used in the same mold by a single injection, a double injection or a triple injection. Such structural details permit the device 1 to provide a secure and firm or tight grip around a predetermined item, such as the steering wheel 10. FIGS. 3-4 show an embodiment of the device 1 created using a single injection mold where all portions (e.g., portions 3, 4, 5 as discussed further below) of the band 2 are integral. By way of a further example, FIG. 5 shows how the three injection process (shown diagrammatically where the injection zones 3a, 4a, 5a (further discussed below) are located) ensures firmed edges around a predetermined item, such as a steering wheel 10 of a vehicle. As best seen in FIGS. 3-5, the band 2 of the device 1 may include three portions: a first portion 3, a second portion 4, and a third portion 5. Alternatively, the band of the device 1 may include two portions: the first portion 3 and the second portion 4 (best seen in FIGS. 6-8B and discussed further below) such that a double injection mold may be used to create the device 1. The first portion 3 and the second portion 4 may be at least one of co-linear, substantially co-linear, co-planar, substantially co-planar, co-axial and substantially co-axial, and/or the second portion 4 and the third portion 5 may be at least one of co-linear, substantially co-linear, co-planar, substantially co-planar, co-axial and substantially co-axial.

As best seen in FIGS. 1-2, the band 2 may have at least four surfaces, the at least four surfaces including a first surface, a second surface, a third surface and a fourth surface, the first and second surfaces being substantially parallel to each other, the third and fourth surfaces being substantially parallel to each other and the third and fourth surfaces extending between the first and second surfaces. In one or more embodiments (see e.g., the embodiments of FIGS. 6-8B), the first side of the band 2 may include a first surface of the first portion 3 and a first surface of the second portion 4. The second side of the band 2 may include a second surface of the first portion 3 and a second surface of the second portion 4. The third side of the band 2 may include a first side of the first portion 3. The fourth side of the band 2 may include a first side of the second portion 4, the second portion 4 having a second side and the first portion 3 having a second side that is located adjacent to, and/or connected to, the second side of the second portion 4. In at least one or more other embodiments (see e.g., the embodiments of FIGS. 4-5 and 9A-10), the first side of the band 2 may include a first surface of the first portion 3, a first surface of the second portion 4 and a first surface of the third portion 5. The second side of the band 2 may include a second surface of the first portion 3, a second surface of the second portion 4 and a second surface of the third portion 5. The third side of the band 2 may include a first side of the first portion 3. The fourth side of the band 2 may include a first side of the third portion 5, the second portion 4 having a first side and a second side, the first portion 3 having a second side that is located adjacent to, and/or connected to, the first side of the second portion 4 and the third portion 5 having a second side that is located adjacent to, and/or connected to, the second side of the second portion 4.

Because the shape of a steering wheel 10 may be different from vehicle to vehicle, any of the single, the double and the three injection processes may be used to create the device 1 to ensure a comfortable feeling when a user grabs the grip aid device 1 and a tight grip around the steering wheel 10, without using any additional grip or stretch or flex modifying structure, such as, but not limited to, a stitching, glue, a bungee cord, string, Velcro tape, one or more snaps, etc. By using any of the single, double and three injection molds or processes in accordance with one or more aspects of the present invention, at least one portion (e.g., the second portion 4) of the grip aid device 1 may have an initial diameter as shown in FIGS. 3-4, and may be stretched to fit and/or to tightly grip the predetermined item, such as the steering wheel 10, which may or may not have a different diameter. For example, the steering wheel 10 may have a diameter of 12 inches, and the device 1 stretches to take the shape of the steering wheel 10.

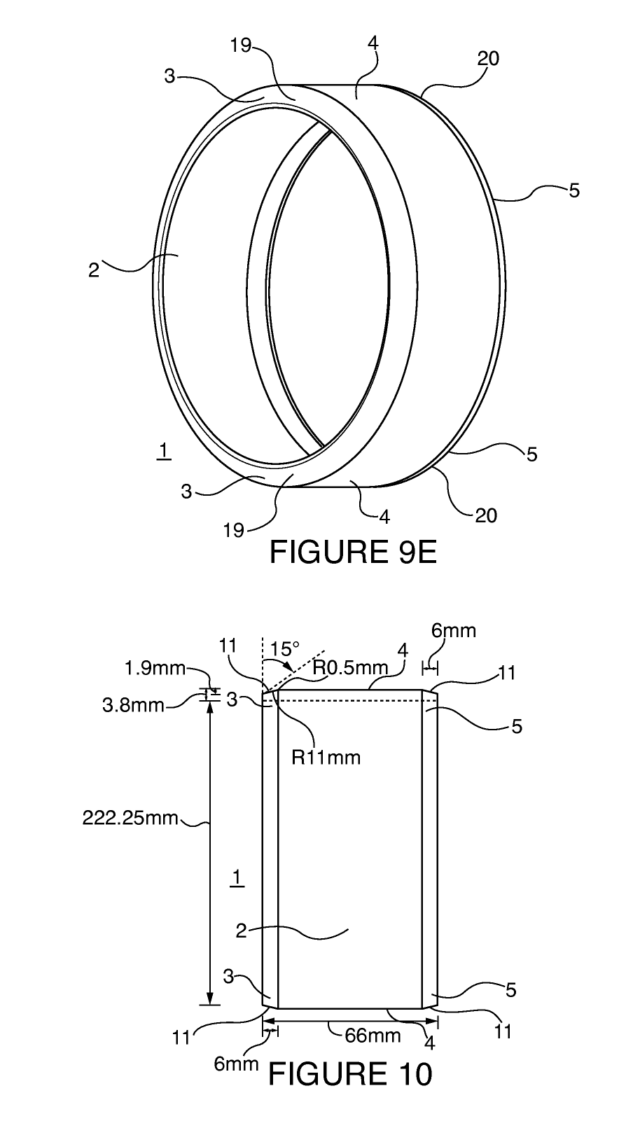

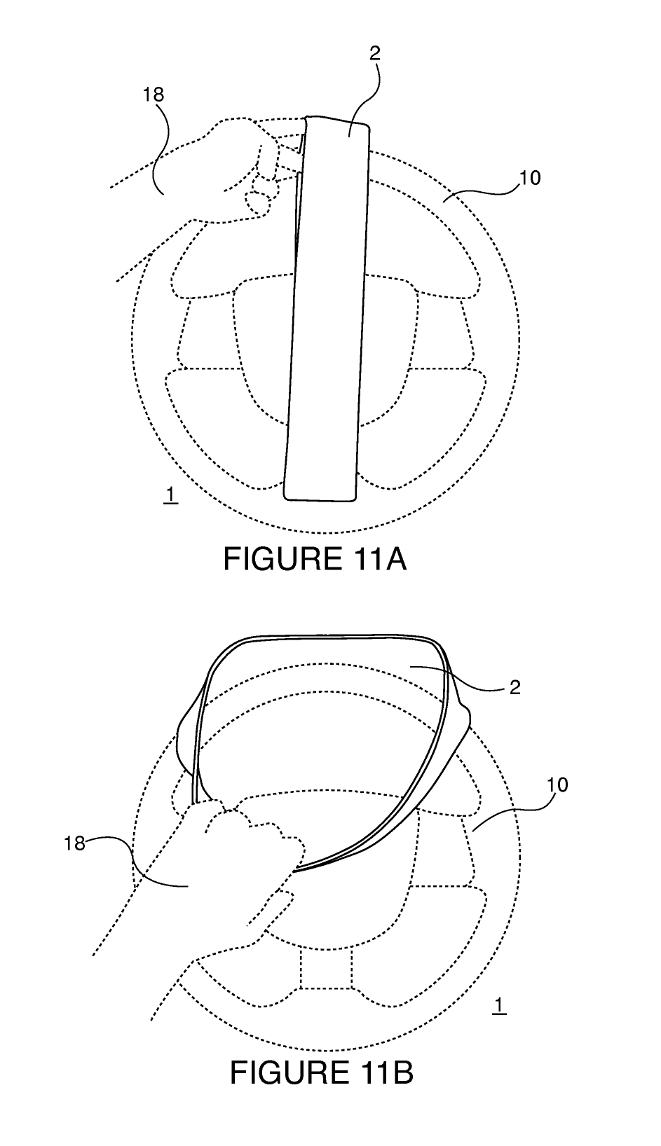

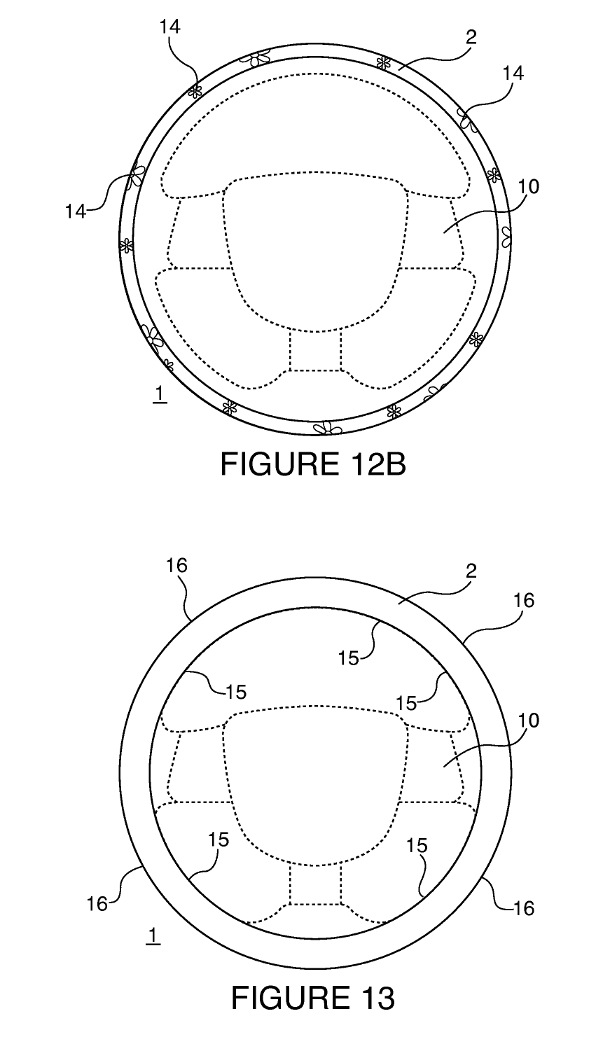

As shown in FIG. 4 (and in FIGS. 9B-10 which are further discussed below), the first portion 3 may be disposed at, and/or define, a first edge of the band 2, and the third portion 5 may be disposed at, and/or define, a second edge of the band 2. Preferably, the first and third portions 3, 5 define opposite edges of the band 2. The second portion 4 may be disposed adjacent to, and in between, the first and third portions portion 3, 5, thereby defining a middle portion of the band 2 of the grip aid device 1. Preferably, a harder and/or firmer silicone or rubber (e.g., harder and/or firmer with respect to the rubber or silicone used for the second portion 4), such as, but not limited to, a rubber or silicone having about 5% less stretch than the rubber or silicone of the second portion 4, a rubber or silicone having about 10% less stretch than the rubber or silicone of the second portion 4, a rubber or silicone having about 15% to about 20% less stretch than the rubber or silicone of the second portion 4, etc., is included in the first portion 3 (e.g., at a predetermined injection location, such as the injection location 3a as shown in FIG. 5) and the third portion 5 (e.g., at a predetermined injection location, such as the injection location 5a as shown in FIG. 5) such that the first and third portions 3, 5 include (and/or are made of) the harder and/or firmer silicone or rubber. While the first and third portions 3, 5 may be made of the same or similar rubber or silicone (e.g., the addition cure silicone elastomer as discussed herein), the first and third portions 3, 5 may have different textures, structure and stretching abilities from each other such that one of the first and third portions 3, 5 may grasp or grip the predetermined item, such as the steering wheel 10, more than the other of the first and third portions 3, 5. For example, the first portion 3 may have a stretch of about 10% less than the stretch of the second portion 4 whereas the third portion 5 may have a stretch of about 15-20% less than the stretch of the second portion 4. The percentages of stretchiness that each of the portions 3, 5 possesses may be varied as needed (e.g., for differently sized and shaped objects to which a user desires to grip more tightly). In at least one embodiment, the first portion 3 may have a different thickness than the thickness of the third portion 5 in order to achieve the different, desired amounts of stretchiness. By injecting a harder and/or firmer rubber or silicone in and/or at the first portion 3 (best seen in FIGS. 4-5) and in and/or at the third portion 5 (best seen in FIGS. 4-5) and a less firm and/or looser silicone or rubber in and/or at the middle portion 4 (e.g., at a predetermined injection location, such as the injection location 4a as shown in FIG. 5) (best seen in FIGS. 4-5), the band 2 of the grip aid device 1 operates to grip the predetermined item, such as the steering wheel 10 (as discussed further below), while providing and/or maintaining firmness on the inner edge (e.g., an edge that is disposed or located closer to the center of mass of the predetermined item as compared to another edge of the predetermined item that is disposed or located further away from the center of mass of the predetermined item, an edge that is disposed or located closer to the center of the steering wheel 10 as compared to another edge of the steering wheel 10 that is disposed or located further away from the center of the steering wheel 10, at a predetermined circumference or line (such as the circumference or line 15 shown in FIG. 13 discussed below) that is closer to the center of the predetermined item (such as the steering wheel) than another predetermined circumference or line (such as the circumference or line 16 shown in FIG. 13 discussed below), etc.) of the predetermined item, such as the steering wheel 10. Such a structural attribute of the device 1 is provided by the structure of the device 1 as discussed herein without additional support, such as, but not limited to, an elastic stitch at the edge to make the inner edge firmer. Alternatively, in one or more embodiments, the device 1 may include an elastic stitch to add a desired amount of firmness to the device 1. Preferably, the device 1 employs differently stretched plastic, silicone and/or rubber only (e.g., plastic, silicone and/or rubber having different amounts of stretch resulting from the composition of the plastic, silicone and/or rubber, the plastic, silicone and/or rubber having different amounts of stretch resulting from having different dimensions or structure (e.g., length, width, thickness, slope, taper, chamfered surface, one or more recesses or grooves that operate to permit greater stretch or flex of the device 1, etc.) from each other, etc.) without the use of an elastic stitch or additional structure to modify the stretch or flexibility of the device 1. In such an embodiment, the device 1 is designed and sized and shaped to look like one integral structure having different texture at one or more portions (e.g., the first portion 3, the second portion 4, the third portion 5, etc.) of the device 1. In one or more embodiments, the portions 3, 4, 5 of the device 1 are integral. In one or more other embodiments, the portions 3, 4, 5 of the device 1 are formed or created in separate molds but are then connected or combined such that the portions 3, 4, 5 provide the appearance of being integral (e.g., the portions 3, 4, 5 are melded, merged, and/or blended together; the portions 3, 4, 5 are fused together; the portions 3, 4, 5 are melted together; etc.). In at least one embodiment, the first and third portions 3, 5 may each have a width of about 10.0 mm and a thickness of about 2.0 mm, and the width of the band 2 of the device 1 may be about 95.0 mm (see e.g., FIG. 4). The diameter of the device 1 may be about 220.0 mm (best seen in FIGS. 3-4). Alternatively, as shown in FIG. 5, the width of the band 2 may be about 66.0 mm; the width of the first and third portions 3, 5 may be about 12 mm each; the width of the second portion 4 may be about 42 mm; and the diameter of the device 1 may be about 222.25 mm. The thickness of the second portion 4 of the band 2 of the device 1 may be about 2.0 mm or may be substantially about 2.0 mm (see e.g., FIGS. 4, 7A and 8A).

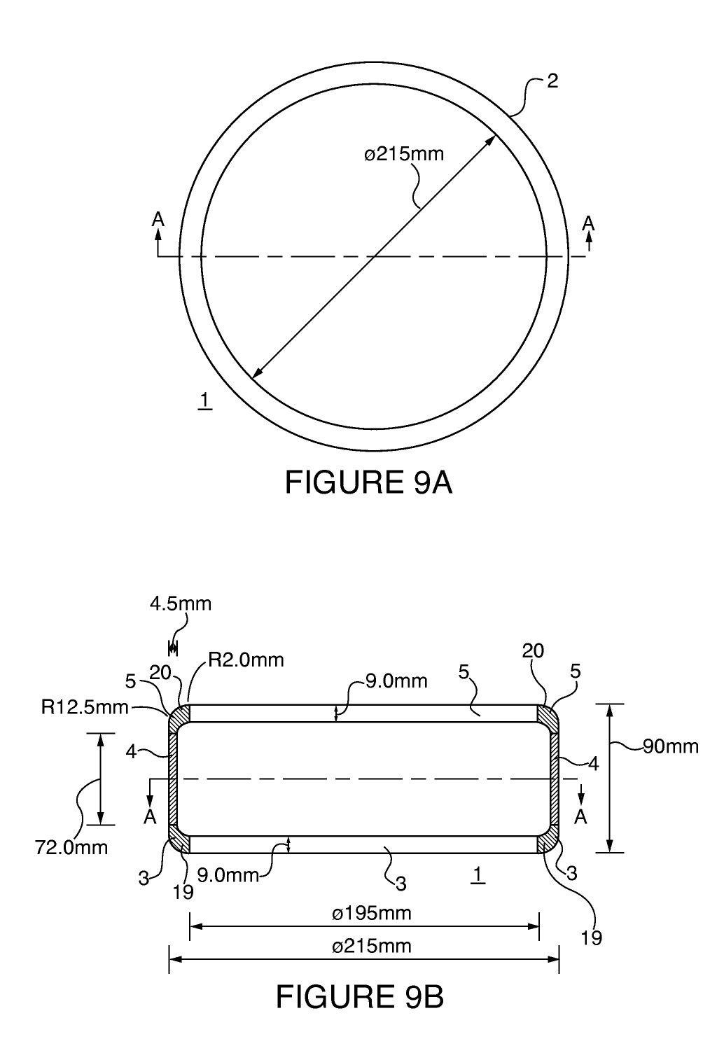

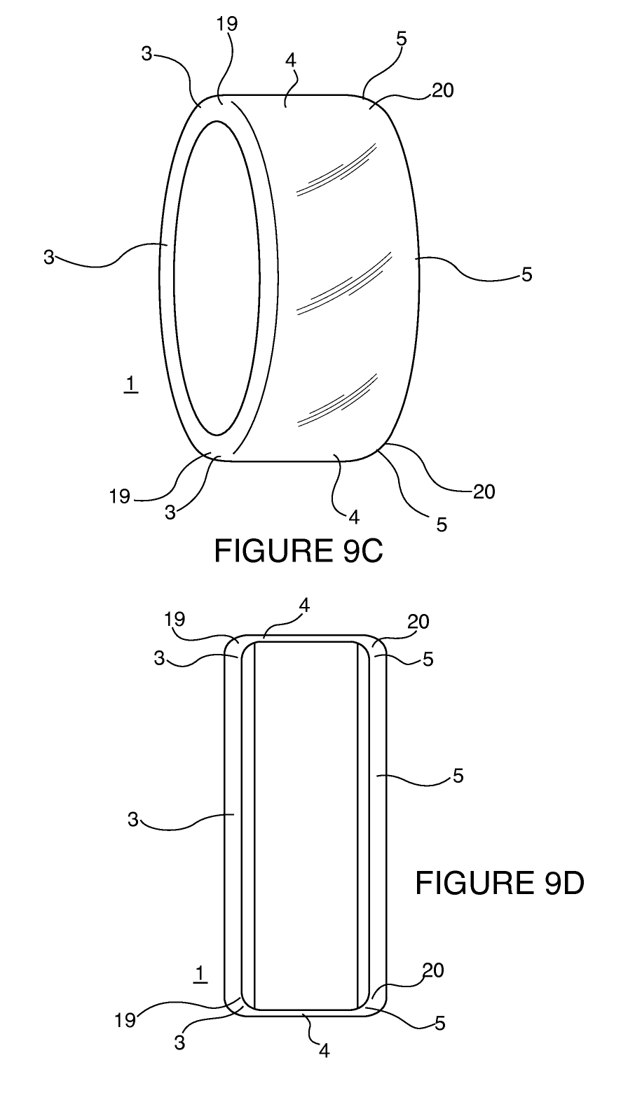

As best seen in FIGS. 6-8A, the device 1 may alternatively be formed with only one injection (best seen in FIGS. 6-7C) or two injections (best seen in FIGS. 8A and 8B) (rather than three injections as aforementioned) such that the device 1 may include only the first portion 3 and the second portion 4. Preferably, a harder and/or firmer silicone, plastic and/or rubber (e.g., harder and/or firmer with respect to the rubber, plastic and/or silicone used for the second portion 4), such as, but not limited to, a rubber, plastic and/or silicone having about 5% less stretch than the rubber, plastic and/or silicone of the second portion 4, a rubber, plastic and/or silicone having about 10% less stretch than the rubber or silicone of the second portion 4, a rubber, plastic and/or silicone having about 15% to about 20% less stretch than the rubber, plastic and/or silicone of the second portion 4, etc., is injected at the first portion 3 such that the first portion 3 includes (and/or is made of) the harder and/or firmer silicone, plastic and/or rubber. By injecting a harder and/or firmer silicone, rubber and/or plastic in and/or at the first portion 3 (best seen in FIGS. 7A-8A) and a less firm and/or looser silicone, rubber and/or plastic in and/or at the middle portion 4 (best seen in FIGS. 7A-8A), the band 2 of the grip aid device 1 operates to grip the predetermined item, such as the steering wheel 10 (as discussed further below), while providing and/or maintaining firmness on the inner edge (e.g., an edge that is disposed or located closer to the center of mass of the predetermined item as compared to another edge of the predetermined item that is disposed or located further away from the center of mass of the predetermined item, an edge that is disposed or located closer to the center of the steering wheel 10 as compared to another edge of the steering wheel 10 that is disposed or located further away from the center of the steering wheel 10, at a predetermined circumference or line (such as the circumference or line 15 shown in FIG. 13 discussed below) that is closer to the center of the predetermined item (such as the steering wheel) than another predetermined circumference or line (such as the circumference or line 16 shown in FIG. 13 discussed below), etc.) of the predetermined item, such as the steering wheel 10. Additionally or alternatively, the harder and/or firmer structural attribute of the device 1 may be obtained by having one portion (e.g., the portion 3) thicker than the other portion (e.g., the portion 4). When using different thicknesses to achieve the varying stretch or flexibility of the device 1, the same rubber, plastic and/or silicone may be used for any of the portions (e.g., the portion 3, the portion 4, the portion 5, etc.). In at least one embodiment, the first portion 3 may have a width of about 8.6 mm and a thickness of about 4.0 mm or about 4.5 mm, and the width of the band 2 of the device 1 may be about 95.0 mm (see e.g., FIG. 7A). The diameter of the device 1 may be about 220.0 mm (best seen in FIGS. 6-7A). Alternatively, as shown in FIGS. 7B-7C, the width of the band 2 may be about 94.0 mm (plus or minus about 3 mm); the width of the first portion 3 may be about 12.5 mm (plus or minus about 3 mm); the thickness of the first portion 3 may be about 4.2 mm (plus or minus about 0.2 mm); the thickness of the second portion 4 may be about 3 mm (plus or minus about 0.2 mm); and the diameter of the device 1 may be about 216 mm (plus or minus about 5 mm).

The first portion 3 may further include an edge 6 (best seen in FIGS. 7B-7C and 8A-8B) having a thicker dimension that the thickness dimension of the second portion 4. The difference in thickness between at least one portion of the first portion 3 and the second portion 4 defines a rim or curved edge that operates to improve the grip of, and/or to secure, the device 1 onto a predetermined item (such as the steering wheel 10) from the inner side of the device 1. Preferably, the device 1 as shown in FIGS. 6-8B having only the first portion 3 and the second portion 4 (and not using the third portion 5 as discussed above) is installed on the predetermined item (such as the steering wheel 10) such that the second portion 4 grips the outer side or edge of the predetermined item and such that the first portion 3 grips the inner side or edge of the predetermined (see examples discussed above for inner and outer sides or edges). The thickness may taper or increase gradually over the width of the first portion 3. For example, the thickness of the first portion 3 may increase over the width of the first portion 3 as the first portion 3 extends away from the second portion 4 (best seen in FIGS. 7B-7C and 8A-8B). The edge 6 discussed herein may be employed with the device 1, regardless of the number of injections used to form the device 1. For example, as shown in one embodiment in FIG. 8A, the second portion 4 may have a thickness of 2.0 millimeters (“mm”), and the first portion 3 may include the edge 6 and have a thickness, e.g., 4.5 mm, greater than the thickness of the second portion 4. Along the length of the edge 6, the edge 6 of the first portion 3 may include different sizes, shapes and/or structure, such as, but not limited to, the edge 6 being smooth, the edge 6 being curvy, the edge 6 being chamfered, the edge 6 being angled, the edge 6 being sloped, the edge 6 being tapered, etc. Alternatively, in at least one embodiment employing only the first portion 3 and the second portion 4 (see e.g., FIGS. 6-8B), the thickness of the first portion 3 and the thickness of the second portion 4 may be the same or substantially the same.

Additionally or alternatively, the first portion 3 may include a first section 7 and a second section 8 where the first section 7 has a thickness that increases over the width thereof as the first portion 3 extends away from the second portion 4 as discussed above and the second section 8 has a thickness that remains constant or substantially constant over the width thereof (best shown in FIGS. 7B and 7C). For example, the first section 7 of the first portion 3 may have the same thickness as the second portion 4 along the portion of the first section 7 of the first portion 3 that is adjacent to, and contacts (or connects with), the second portion 4, and the thickness of the first section 7 of the first portion 3 may increase as the first portion 3 extends away from the second portion 4. As best seen in FIGS. 7B-7C, the first section 7 of the at least two sections 7, 8 of the first portion 3 may include a gradually increasing or tapered thickness (e.g., the thickness of the first section 7 increases as the first section 7 extends away from the second portion 4 of the band 2), and the second section 8 of the at least two sections 7, 8 of the first portion 3 may include a constant thickness along with width thereof. The second section 8 of the first portion 3 may have a thickness that is the same as the thickest part of the first section 7 (e.g., the portion of the first section 7 that is adjacent to, and contacts (or connects with), the second section 8). In at least one embodiment (e.g., where the first portion 3 has a width of about 12.5 mm (plus or minus 3 mm) as aforementioned), the width of the first section 7 may be about 5.16 mm (plus or minus 3 mm) and the width of the second section 8 may be about 7.34 mm (plus or minus 3 mm). In at least one embodiment, the thickness of the first portion 3 is greatest at at least the edge 6 thereof.

Preferably, the device 1 has the edges firmer and/or harder as described above. To accomplish this, the device 1 may include the first and third portions 3, 5 as shown in FIGS. 9A-9E (best seen in FIG. 9B) each having a thickness that is about doubled, e.g., about 9 mm, in comparison to the thickness of the second portion 4 (e.g., where the thickness of the section 4 is about 4.5 mm) or in comparison to any other remaining portion of the band 2, which may have a thickness of about 4 mm to about 5 mm. Preferably, the first portion 3 includes a curved end 19 around the device 1, and the third portion 5 includes a curved end 20 around the device 1. With such structure, the device 1 may operate to stretch up to 50% of its size while providing a comfortable grip around the predetermined item (such as the steering wheel 10). As such, the structure of the rubber or silicone, such as, but not limited to, the addition cure silicone elastomer, of the grip aid device 1 operates to firmly grasp an outer side or edge (e.g., a side further from the user of the predetermined item, such as the steering wheel 10; a side that is on the opposite side (e.g., the side of the predetermined item that faces away from the user or that is disposed such that the remaining portion of the predetermined item is located between the outer side and the user); a predetermined circumference or line (such as the circumference or line 16 shown in FIG. 13) that is more distant from the center of the predetermined item (such as the steering wheel 10) than another predetermined circumference or line (such as the circumference or line 15 shown in FIG. 13); etc.) of the predetermined item, such as the steering wheel 10, and an inner side or edge (e.g., an edge that is disposed or located closer to the center of mass of the predetermined item as compared to another edge of the predetermined item that is disposed or located further away from the center of mass of the predetermined item, an edge that is disposed or located closer to the center of the steering wheel 10 as compared to another edge of the steering wheel 10 that is disposed or located further away from the center of the steering wheel 10, at a predetermined circumference or line (such as the circumference or line 15 shown in FIG. 13 discussed below) that is closer to the center of the predetermined item (such as the steering wheel) than another predetermined circumference or line (such as the circumference or line 16 shown in FIG. 13 discussed below); a side closer to the user of the predetermined item, such as the steering wheel 10; a side that is on the closer side (e.g., the side of the predetermined item that faces towards the user or that is disposed such that the inner side is located between the remaining portion of the predetermined item and the user); etc.) of the predetermined item, such as the steering wheel 10. As such, the curved end 20 of the second portion 5 may be disposed on the outer side of the predetermined item, such as the steering wheel 10, and the curved end 19 of the first portion 3 may be disposed on the inner side of the predetermined item, such as the steering wheel 10 or vice versa. In at least one embodiment, when the device 1 stretches around the predetermined item, such as the steering wheel 10, about 90% of the grip aid device 1 may be firmly grasping the predetermined item, such as the steering wheel 10. Because the portion 4 of the device 1 has a larger thickness than previously discussed embodiments as aforementioned and because the portions 3, 5 have larger thicknesses than the portion 4 as aforementioned, the device 1 operates to stretch firmly and tightly around the predetermined item, such as the steering wheel 10, while providing a greater amount of strength, stretchability and/or flexibility. As shown in FIG. 9B, the width of the band 2 may be about 90 mm; the thickness of the second portion 4 may be about 4.5 mm; the diameter from one end to the other end of the device 1 (e.g., when the device 1 is “at rest”, the device 1 is not being stretched and/or flexed, etc.) may be about 215 mm, and the diameter from the curved end 19, 20 on one side of the device 1 to the curved end 19, 20 on the other side of the device 1 (e.g., from the curved end 19 on one side of the device 1 to the curved end 19 located on the other side of the device 1; from the curved end 20 on one side of the device 1 to the curved end 20 located on the other side of the device 1; etc.) may be about 195 mm. Alternatively, the diameter from the curved end 19, 20 on one side of the device to the curved end 19, 20 on the other side of the device 1 may be about 190.5 mm, the width of the band 2 may be 85 mm, and/or the diameter from one end to the other end of the device 1 may be about 216 mm.

In one or more embodiments, liquid rubber may be used to make the device 1. Liquid rubber can be thinned with Silicone Thinner or thickened with one or more silicone thickening agents known to those skilled in the art. Preferably, the rubber cures at room temperature (73 degrees F./23 degrees C.) with negligible shrinkage.

As shown in FIG. 10, the grip aid device 1 may include three portions 3, 4, 5 where the first and third portions 3, 5 include a tapered, angled or chamfered surface 11 to modify and/or enhance the comfort settings of the device 1. The width of the first and third portions 3, 5 may be 6 mm, and the thickness of the band 2 may be 3.8 mm. At its narrowest width where the surface 11 is the thinnest due to the taper, angle and/or chamfer, the width may be 1.9 mm. The width of the device 1 may be 66 mm, and the length of the device may be 222.25 mm. The tapered, angled or chamfered surface 11 may have a 15 degree angle with respect to the surface of the band 2 of the device 1.

When making the device 1, preferably vacuum degassing is used to minimize air bubbles in the cured rubber, plastic or silicone.

In accordance with at least one broad aspect of the present invention, at least one process for making the device 1 included the steps of: (i) using a perfect round mold with a thickness of approximately 4 mm in thickness and about 10 inches in diameter, (ii) using a cake pan to achieve the desired round shape so the mold, which was made out of the silicone or rubber material (e.g., the addition cure silicone elastomer), could be poured inside the circle of the cake pan and around it, and (iii) leaving the mold to dry for approximately 12 hours. Afterwards, the cake pan was removed, thereby leaving the space empty to pour the silicone or rubber material (e.g., the addition cure silicone elastomer) into the round shape pan. The rubber was allowed to dry for another 12 hours. When the rubber was completely dry, the mold was pulled out to get a substantially perfect, round rubber band, such as the band 2 discussed above. The band 2 of the steering wheel grip device 1 was then thrown into a dishwasher in a normal cycle with warm water to clean the device 1.

Several tests were conducted on the device 1 as follows:

First, a freezing test was conducted in a home freezer. The device 1 was left in the freezer for approximately 24 hours, and the device 1 successfully did not freeze or lose its shape, flexibility, or color. Just by leaving the band 2 of the device 1 in room temperature, the device 1 absorbed the room temperature in only a matter of minutes to return to its original temperature, particularly because the band 2 absorbs heat a lot more efficiently than most other material or any other material when placed in one or more very cold environments.

Second, several heat tests were conducted. The first one involved placing the steering wheel grip device 1 in boiling water for approximately 30 minutes, and, after the device 1 was removed from the boiling water, the steering wheel grip aid device 1 did not lose its shape, flexibility or color. The second heat test involved placing the steering wheel grip aid device 1 in a microwave for approximately three to five minutes, and the device 1 successfully retained its shape, color, and flexibility. The grip aid device 1 also remained warm and released the heat for about 10 minutes to about 15 minutes after being microwaved for three to five minutes.

A stretch test was conducted on the steering wheel grip device 1 which was left for approximately nine (9) months in the sun, and, again, the device 1 retained its original shape, flexibility, size, and color. Preferably, the device 1 operates to handle both extreme heat and cold such that the device 1 helps at least one of: (i) in the winter by providing a warmer, softer surface on the steering wheel for a driver to touch; and (ii) in the summer by providing a cooler surface on the steering wheel for the driver to touch. Preferably, the band 2 of the device 1 (e.g., when the band 2 being made from addition cure silicone elastomer) is resistant to extreme temperatures and/or to temperature changes, and in one or more embodiments, the device 1 may return to at least one of its original temperature (e.g., the temperature at which the device 1 was before the temperature change), to room temperature, to a temperature substantially near room temperature, to a temperature substantially between an extreme cold temperature and an extreme hot temperature, etc. As discussed further below, the device 1 may operate to provide a steering wheel with a unique look.

With 25 years of professional driving experiences, including owning and managing a car wash business, the inventor knows that a grip is extremely useful when holding the steering wheel for various reasons, including, but not limited to, avoiding hand slipping while making turns, avoiding the cold or hot touch of the steering wheel, avoiding or preventing sweating hands behind the wheel, etc. Indeed, the device 1 provides a better grip of or on the steering wheel, especially when the device 1 is made from addition cure silicone elastomer.

Preferably, the device 1 operates to have a warm feeling (e.g., similar to wearing a glove but without having to actually wear a glove when holding the steering wheel) (e.g., the warm feeling may be obtained via preheating the device 1 as discussed further below). Especially, since the present invention is taking the shape of the actual steering wheel (e.g., a steering wheel that is made from vinyl material, leather and/or fiberglass used by most car manufacturers), the driver of the vehicle and/or the user of the device 1 preferably operates the vehicle while feeling like there is nothing on the steering wheel or without noticing that the device 1 is disposed on the steering wheel. As a result, the device 1 operates to provide a comfortable experience that is not bulky and noticeable like other insufficient steering wheel covers.

The warm feeling of the device 1 may be provided in accordance with at least one aspect of the invention. Specifically, new and improved methods of using the grip aid device 1 are disclosed herein. In accordance with at least one aspect of the invention, the grip aid device 1 may be preheated by a user 18 (as shown in FIGS. 11A-11C) and then applied to the predetermined item (e.g., a steering wheel (such as but not limited to the steering wheel 10 as shown in FIGS. 11A-13 and as discussed further below), a jar, a can, etc.).

Preferably, the preheated grip aid 1 is heated to a predetermined temperature such that the preheated grip aid 1 operates to at least one of: provide the user 18 with a warm, comfortable grip or feeling for a predetermined amount of time (e.g., 10 minutes, 15 minutes, about 10 minutes, about 15 minutes, about 10 minutes to about 15 minutes, etc.); protect the user 18 from a cold, harsh environment in which the predetermined item was located (e.g., the predetermined item may be cold, the predetermined item may be as cold as the cold, harsh environment, etc.); and protect the user 18 from the cold temperature of the predetermined item (e.g., after the predetermined item was located in a cold, harsh environment for a predetermined amount of time). Preferably, the preheated grip aid device 1 operates to provide a sufficient amount of heat and/or comfort to the user 18 until the heat of the predetermined item (e.g., a steering wheel (such as but not limited to the steering wheel 10 as shown in FIGS. 11A-13 and as discussed further below), a jar, a can, etc.) rises to a comfortable temperature. In at least one embodiment of the method of using the grip aid device 1, when the grip aid device 1 is preheated and then installed on, or applied to, the steering wheel 10 as shown in FIGS. 11A-13, preferably the grip aid device 1 operates to provide a sufficient amount of heat and/or comfort to the user 18 until the heat of the vehicle in which the steering wheel 10 is located rises to a comfortable temperature (e.g., when a heater is turned on in the vehicle, when the vehicle is located in cold weather, when the vehicle is parked outside in the winter, etc.).

A predetermined heating source (e.g., a microwave, boiling water, a fireplace, leaving the grip aid device 1 exposed to the sun, etc.) may be used to pre-heat the grip aid device 1. For example, after a microwave is used to heat the grip aid device 1 as aforementioned (for the heat test), the grip aid device 1 may be removed from the microwave and installed on, or applied to, the predetermined item (e.g., the steering wheel 10 as shown in FIGS. 11A-13). Preferably, the predetermined heating source is located externally to the predetermined item (e.g., a microwave is typically located outside of a vehicle in which a steering wheel is located). Additionally or alternatively, in one or more embodiments of the invention, the predetermined heating source may be located internally.

Preferably, the preheated grip aid device 1 is used in a vehicle, car, etc. by preheating the device with the predetermined heating source (e.g., in a microwave, boiling water, leaving in the sun, etc.) before use in the vehicle, car, etc. Additionally or alternatively, the preheated grip aid device 1 may be used to add a grip to any predetermined device (as disclosed herein or to other devices known to those skilled in the art).

Each driver (e.g., the user 18) has a different habit of holding the wheel while driving or parking the vehicle. For example, some drivers, when pulling into a tight parking space, use the palm of their hand to steer the wheel while other drivers tend to use both hands to perform the same action. Even though different drivers have different ways of holding steering wheels, the present invention provides a comfortable fit for every driver, regardless of the one or more preferences for holding the wheel of such drivers. In one or more embodiments, comfort is achieved or improved because the steering wheel grip device 1 is made from 100% silicone or addition cure silicone elastomer.

The standard steering wheel diameter size goes somewhere between 14½″ and 15½″ round, but the present invention (the “Stretchy Grip” device 1) is preferably somewhere between 10″ to 12″ round or in diameter (see e.g., FIG. 1) such that the dimensions enable the silicone or rubber to stretch and provide the desired firmness and tightness around the wheel, thereby leaving the driver or the user 18 with a better grip to the steering wheel. This also gives the driver more control when pulling in and out of any space, such as tight spaces, and is anti-slip (i.e., the device 1 prevents slipping off of a steering wheel and prevents the hand(s) of the driver from slipping off of the device 1). Indeed, the device 1 makes drivers want to keep their hands on the wheel.

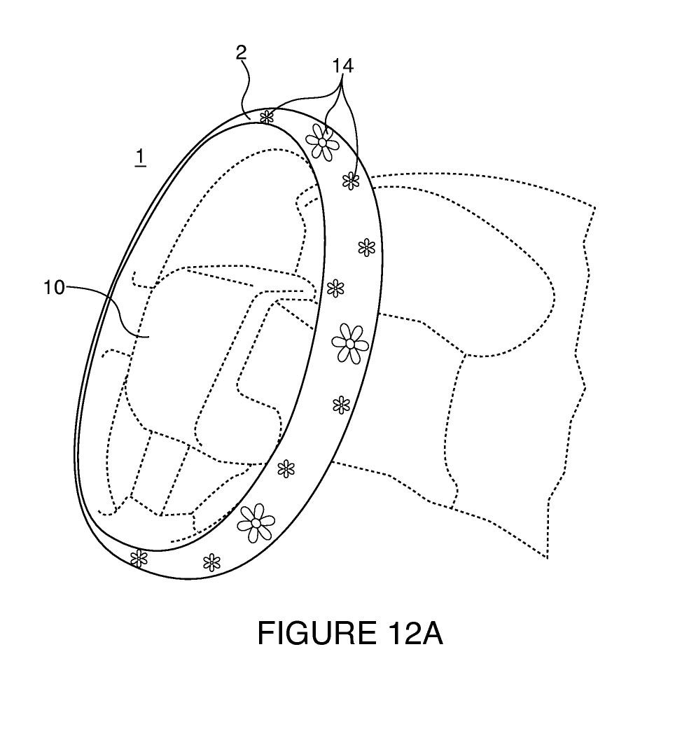

The steering wheel grip aid device or cover may be etched or may have designs and/or messages included thereon. Indeed, those skilled in the art will recognize that users can supplement the look of the grip aid device with attached designs 14 (best seen in FIGS. 12A-12B), such as, but not limited to, different textures, text, designs, graphical designs, colors, patterns, different widths, attached embellishments, finishes, appliqués, etc. As shown in FIG. 9C, the rubber or silicone of the device 1 may be transparent or translucent such that any designs 14 added to the device 1 may be seen through the rubber or silicone. For example, at least one embodiment of the present invention may carry effective messages, such as, but not limited to, the dangers of texting and driving, cancer awareness, etc. The colors may vary, and the device 1 may also be glow in the dark. The size of the device may be any of the following: about 10″ round, about 10½″ round, about 11″ round, about 11½″ round, about 12″ round, about 12½″ round, between about 10″ round and about 12½″ round, between about 10″ round and about 10½″ round, between about 10″ round and about 11″ round, between about 10″ round and about 11½″ round, between about 10″ round and about 12″ round, between about 10½″ round and about 11″ round, between about 10½″ round and about 11½″ round, between about 10½″ round and about 12″ round, between about 10½″ round and about 12½″ round, between about 11″ round and about 11½″ round, between about 11″ round and about 12″ round, between about 11″ round and about 12½″ round, and between about 12″ round and about 12½″ round. The width of the grip may be any of: 1¼″, 1½″, 1¾″, 2″, 2¼″, 2½″, and2¾″. The width may be modified depending on the size and shape of the predetermined item on which the grip aid device 1 is being applied or disposed.

Preferably, the grip aid device 1 is sized and shaped such that the device 1 stretches to fit and take the shape of the standard steering wheel 10 (best seen in FIGS. 11A-13) or any steering wheel to which the aid device 1 is being applied. While the steering wheel 10 of a car is shown in FIGS. 11A-13, the device 1 may be used as a steering wheel cover grip for any other type of vehicle as well, such as, but not limited to, a bulldozer, a digger, an SUV, a school bus, truck, a boat, a bus or other types of automobiles or wheel driving instruments. As a result, the device 1 may be sized and shaped depending on the size of the vehicle steering wheel, the drivers using the wheel, or any other object to which the device 1 may be applied. Just like there are many different types of pillow cases for pillows, the device 1 may be sized and shaped to accommodate different steering wheels for different drivers.

Additionally or alternatively, the device 1 may be used for shopping carts (e.g., placed around the perimeter of the shopping card for padding) to prevent injuries or damages on cars in one or more parking lots, especially where the shopping carts are of the larger sized variety. Similarly, the device 1 may be placed around tables, such as a small coffee table, of any shape (e.g., square or round), to prevent one or more individuals from bumping their legs or bodies on the edge(s) of the tables. The device 1 may even be used to provide or improve a grip to equipment items, such as, but not limited to, gaming platform or personal computer (“PC”) game controller(s), one or more forklifts, etc.

The device 1 may even be used as, or to display, a design around a flower pot, and the device 1 may be used to support the lower back of a person using the device 1 like a supporting belt.

Additionally, the Stretchy Grip silicone, plastic and/or rubber device, such as the device 1, is 100% dishwasher safe, does not leave any marks on the original steering wheel, and does not require sewing or strings or any type of glue to be placed on the wheel.

The present invention may be used in a variety of ways. For example, a smaller size could be used for a steering wheel of a lawn mower, or a golf cart, or for a game (e.g., of a gaming console, of a PC, etc.) with a hand held steering wheel. Additionally, the grip device 1 is not limited to application on a steering wheel only, and may be used to add desired grip aid to any device or product. For example, the device 1 may be sized and shaped (and the size and shape thereof may be reduced such that the device 1) could be used for a grip to open a jar (e.g., a pickle jar). As such, the present invention is an improved device for providing a grip to any desired surface. By placing the round shape of the device 1 around the jar cover and simply twisting the device 1, the jar cover opens with ease. The device 1 provides the grip and force needed to open such tight and hard-to-open jars.

By way of an example of another application for which the device 1 may be used, the device 1 could also be used to secure a garbage bag in its pail. By placing the round band 2 around the bag and garbage can or pail, the device 1 tightens and ensures a firm no-slip grip. Afterwards, the device 1 may be removed and thrown into the dishwasher or washing machine for cleaning if desired.

A fragrance could also be added to the silicone of the device 1 for a scent to fill a vehicle of the user, to mask the scent of garbage in a garbage pail, etc. In at least one embodiment in this case, the present invention provides the benefit of having two in one (i.e., grip and scent in one device 1). The device 1 provides a useful way to support the user's favorite teams, to promote sponsoring, to help raise money for any organizations such as cancer societies, etc., to support the user's child's school, etc. The device 1 may additionally or alternatively display one or more favorite characters, actors, singers/groups, etc. of the user of the device 1.

One or more colors may be applied to the device 1, and/or the device 1 may include one or more colors. For example, different colors can be used for the device 1 to tag and identify cars for different companies, e.g., companies who have big car garages, school buses, car services, etc. may use one color, where another company may employ a different color. Those skilled in the art will appreciate various methods and techniques for application of the one or more colors to the grip aid device 1.

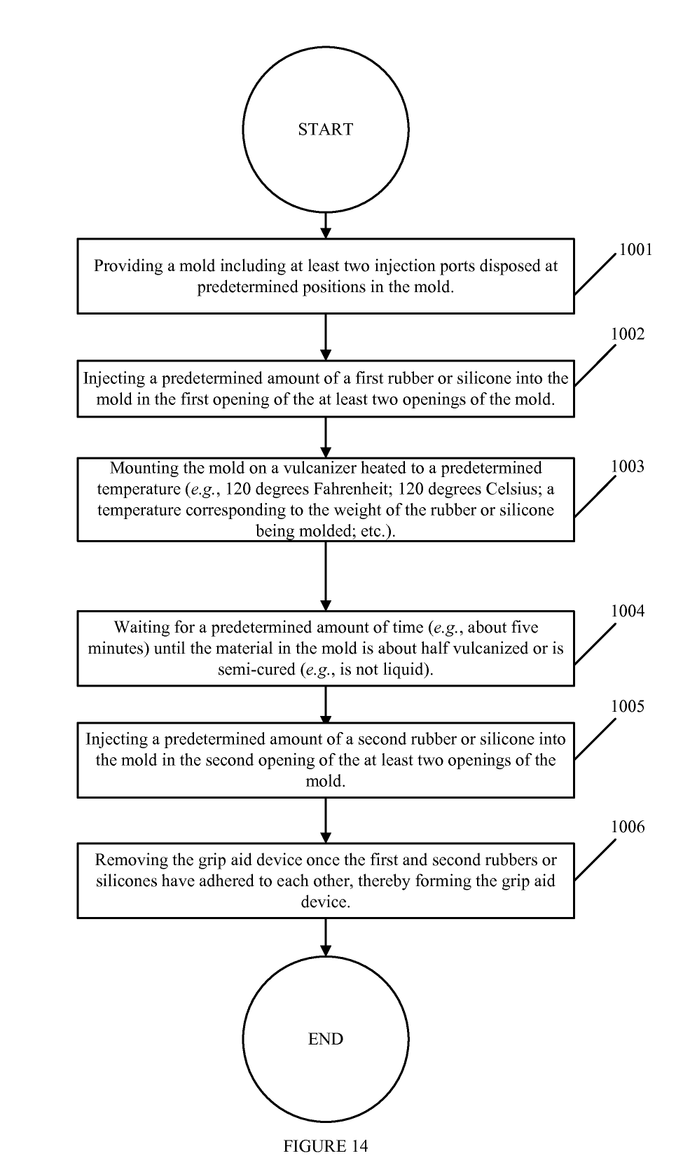

In accordance with at least one aspect of the present invention, a method for making a grip aid device is provided (as shown in FIG. 14). The method of making the grip aid device may include: (i) providing a mold including at least two injection ports disposed at predetermined positions in the mold (Step 1001 in FIG. 14); (ii) injecting a predetermined amount of a first rubber or silicone into the mold in the first opening of the at least two openings of the mold (Step 1002 in FIG. 14); (iii) mounting the mold on a vulcanizer heated to a predetermined temperature (e.g., 120 degrees Fahrenheit; 120 degrees Celsius; a temperature corresponding to the weight of the rubber or silicone being molded; etc.) (Step 1003 in FIG. 14); (iv) waiting for a predetermined amount of time (e.g., about five minutes) until the material in the mold is about half vulcanized or is semi-cured (e.g., is not liquid) (Step 1004 in FIG. 14); (v) injecting a predetermined amount of a second rubber or silicone into the mold in the second opening of the at least two openings of the mold (Step 1005 in FIG. 14); and (vi) removing the grip aid device once the first and second rubbers or silicones have adhered to each other, thereby forming the grip aid device (Step 1006 in FIG. 14). Because the first and second silicones or rubbers have good flowability, the method may further include using gravity to have the first and second silicones or rubbers flow into predetermined first and second mold levels, respectively, in the mold. The first and second silicones or rubbers may be the same type of silicone or rubber. The first rubber or silicone may flow into a mid-stream level in the mold, and the second rubber or silicone may flow into the predetermined mold level for same. Such steps may be used for the double injection mold process.

For the triple injection mold process, the aforementioned method steps may be used with a mold having at least three injection ports (e.g., the first two injection ports as discussed above plus a third injection port disposed at a predetermined location on the mold). The method may further include the following steps of: (i) waiting for a predetermined amount of time (e.g., about five minutes) until the first silicone or rubber is fully cured, the second silicone or rubber is semi-vulcanized and due to a common curing process the first and second silicones or rubbers have been firmly bonded together; (ii) injecting a predetermined amount of a third rubber or silicone into the mold in the third opening of the at least three openings of the mold; and (iii) waiting for a predetermined amount of time (e.g., about ten minutes) until the curing of the three rubbers or silicones is complete. Once the curing is complete, the mold may be opened, and the product (i.e., the grip aid device 1) may be removed from the mold. The plastic injection port(s) may be cut off from the product (i.e., the grip aid device 1). The first, second and third silicones or rubbers may be the same type of silicone or rubber, and the molded dimensions may be different in the one or more ways described above (e.g., the thicknesses may be different). Alternatively, the first and third silicones or rubbers may be the same type of silicone or rubber, and the second silicone or rubber may be different from the first and third silicones or rubbers. The predetermined locations of the mold for the first, second and third injection points may be arranged in corresponding positions from the bottom to the top of the mold.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A grip aid device for gripping a predetermined item, comprising a band including at least two portions, the at least two portions including a first portion and a second portion adjacent to and connected to each other, wherein the first portion and the second portion have different amounts of at least one of: stretchiness, flexibility and elasticity.

2. The grip aid device of claim 1, wherein the band operates to at least one of:
(i) absorb and release heat to keep a predetermined item warm on, and/or adjacent to, which the band is disposed while retaining its at least one of: stretchiness, flexibility and elasticity;
(ii) be resistant to at least one of extreme temperature(s) and temperature change(s) such that the band helps at least one of: provide a warmer, softer surface on the predetermined item to touch and/or grip and provide a cooler surface on the predetermined item to touch and/or grip;
(iii) return to at least one of: its original temperature at which the band was before the temperature change, room temperature, a temperature substantially near room temperature, a temperature substantially between an extreme cold temperature and an extreme hot temperature, and a predetermined temperature;
(iv) absorb ambient temperature or ambient heat;
(v) provide a better grip on the predetermined item such that one or more hands of a user of the grip aid device does not slip off of the predetermined item or the grip aid device;
(vi) protect the user of the grip aid device from the extreme temperatures and the temperature changes;
(vii) the predetermined item is at least one of: a steering wheel, a jar, a can, a garbage bag, a garbage can, a garbage can and a garbage bag disposed in the garbage can, a shopping cart, a driving instrument, a table, one or more equipment items, a game controller, a forklift, a pot, a flower pot, and the abdomen or the lower back of a user of the grip aid device;
(viii) be preheated or heated to a predetermined temperature prior to being applied to, disposed on and/or adjacent to the predetermined item such that the grip aid device operates to at least one of: provide the user with a warm, comfortable grip or feeling for a predetermined amount of time and/or until the temperature of the predetermined item rises to a predetermined level; protect the user from a cold environment in which the predetermined item was located; and protect the user from the cold temperature of the predetermined item;
(ix) take the shape of the predetermined item on which and/or adjacent to which it is disposed or applied; and
(x) operate as a steering wheel cover when the predetermined item is a steering wheel.

3. The grip aid device of claim 2, wherein at least one of:
(i) the band includes at least one of: plastic, rubber, silicone; addition cure silicone elastomer; a sturdy rubber, a sturdy silicone and a sturdy addition cure silicone elastomer;
(ii) the band is sized and shaped to correspond to, and comply with, one or more dimensions of the predetermined item, thereby operating to at least one of: support and secure itself around the predetermined item, provide a grip for the predetermined item, avoid slipping off of the predetermined item, prevent a hand or hands of a user of the device from slipping off of or from the predetermined item, protect the user from the predetermined item when the predetermined item is hot or cold, and grip the predetermined item with about 90% efficiency such that about 90% of the grip aid device is firmly grasping or gripping the predetermined item;
(iii) the band is substantially 0-shaped or substantially 0-shaped;
(iv) the band further includes a connecting device for at least one of: holding two ends of the band together and holding the first and second portion together;
(v) the band operates to fold and/or bend for easy storage;
(vi) the band does not include at least one of: string, lace, stitching, an elastic stitch, glue, a bungee cord, Velcro tape, and one or more snaps; and
(vii) the band has at least four surfaces, the at least four surfaces including a first surface, a second surface, a third surface and a fourth surface, the first and second surfaces being substantially parallel to each other, the third and fourth surfaces being substantially parallel to each other and the third and fourth surfaces extending between the first and second surfaces.

4. The grip aid device of claim 3, wherein at least one of:
(i) the band has a substantially consistent width along the length of the band;
(ii) the band has a width that is at least one of: about 2 inches, about 95.0 millimeters (“mm”), about 85.0 mm, about 66.0 mm, about 94.0 mm, about 91.0 mm to about 97.0 mm, about 90.0 mm, about 1¼ inches, about 1½ inches, about 1¾ inches, about 2 inches, about 2¼ inches, about 2½ inches, and about 2¾ inches;
(iii) the band has a length that is at least one of: about 14 inches and about 222.25 mm;
(iv) the band has a thickness that is at least one of: about 2 mm to about 3 mm, about 4 mm to about 5 mm, about 2 mm to about 4 mm, about 3 mm to about 5 mm, about 3.8 mm and about 2 mm to about 5 mm; and
(v) the band has a diameter that is at least one of: about 10 inches, about 220.0 mm, about 225.25 mm, about 216 mm, about 211 mm to about 221 mm, about 215 mm, about 14½ inches to about 15½ inches, and about 10 inches to about 12 inches, about 10½ inches, about 11 inches, about 11½ inches, about 12 inches, about 12½ inches, between about 10 inches and about 12½ inches, between about 10 inches and about 10½ inches, between about 10 inches and about 11 inches, between about 10 inches and about 11½ inches, between about 10 inches and about 12 inches, between about 10½ inches and about 11 inches, between about 10½ inches and about 11½ inches, between about 10½ inches and about 12 inches, between about 10½ inches and about 12½ inches, between about 11 inches and about 11½ inches, between about 11 inches and about 12 inches, between about 11 inches and about 12½ inches, and between about 12 inches and about 12½ inches.

5. The grip aid device of claim 4, wherein at least one of:
(i) the first and second portions include at least one of: plastic, rubber, silicone; addition cure silicone elastomer; a sturdy rubber, a sturdy silicone and a sturdy addition cure silicone elastomer;
(ii) the first and second portions, and/or portions thereof, are at least one of co-linear, substantially co-linear, co-planar, substantially co-planar, co-axial and substantially co-axial;
(iii) the first portion has at least one of: about 5% less stretch than the second portion, about 10% less stretch than the second portion, about 15% less stretch than the second portion, about 20% less stretch than the second portion, about 15% to about 20% less stretch than the second portion, and about 5% to about 20% less stretch than the second portion;
(iv) the first portion is melded, merged, fused, melted, and/or blended together with the second portion;
(v) the first and second portions are integral;
(vi) the first side of the band comprises a first surface of the first portion and a first surface of the second portion, the second side of the band comprises a second surface of the first portion and a second surface of the second portion, the third side of the band comprises a first side of the first portion, and the fourth side of the band comprises a first side of the second portion, the second portion having a second side and the first portion having a second side that is located adjacent to, and/or connected to, the second side of the second portion;
(vii) the first portion and the second portion have different textures and/or strengths, thereby resulting in the first and second portions having the different amounts of at least one of: stretchiness, flexibility and elasticity;
(viii) the first portion is disposed at, or defines, a first edge of the band;
(ix) the first portion and the second portion have different thicknesses, thereby resulting in the first and second portions having the different amounts of at least one of: stretchiness, flexibility and elasticity, or the thicknesses of the first portion and the second portion are substantially the same or are the same while the first and second portions have the different amounts of at least one of: stretchiness, flexibility and elasticity;
(x) when the thickness of the first and second portions are not the same, the difference in thickness between the first portion and the second portion defines a rim or curved edge that operates to at least one of improve the grip of, and secure the band onto, the predetermined item;
(xi) the first portion is thicker than the second portion, thereby resulting in the first and second portion having the different amounts of at least one of: stretchiness, flexibility and elasticity; and
(xii) the thickness of the first portion at least one of tapers and increases gradually over the width of the first portion as the first portion extends away from the second portion.

6. The grip aid device of claim 5, wherein at least one of:
(i) the first portion has a width that is at least one of: about 10.0 mm, about 12.0 mm, about 8.6 mm, about 12.5 mm, about 9.5 mm to about 15.5 mm, and about 6 mm;
(ii) the first portion has a thickness that is at least one of: about 2.0 mm, about 4.0 mm, about 4.5 mm, about 4.0 mm to about 4.5 mm, about 4.2 mm, about 4 mm to about 4.4 mm, about 9.0 mm, about double the thickness of the second portion, and about double the thickness of any portion of the band;
(iii) the second portion has a width that is at least one of: about 42.0 mm; about 72.0 mm, about 81.5 mm, about 84.5 mm, about 78.5 mm, about 78.5 mm to about 84.5 mm, about 75.5 mm, about 87.5 mm, about 75.5 mm to about 87.5 mm, about 75 mm, about 86.4 mm, and about 72 mm to about 90 mm; and
(iv) the second portion has a thickness that is at least one of: about 2.0 mm, substantially about 2.0 mm, about 3.0 mm, about 2.8 mm to about 3.2 mm, about 4.0 mm, about 4.5 mm, about 4.0 to about 4.5 mm, about half the thickness of the first portion, and about half the thickness of any portion of the band.

7. The grip aid device of claim 6, wherein the band further comprises a third portion adjacent to and connected to the second portion such that the second portion is disposed between the first and third portions, and at least one of:
(i) the first side of the band comprises a first surface of the first portion, a first surface of the second portion and a first surface of the third portion; the second side of the band comprises a second surface of the first portion, a second surface of the second portion and a second surface of the third portion, the third side of the band comprises a first side of the first portion, and the fourth side of the band comprises a first side of the third portion, the second portion having a first side and a second side, the first portion having a second side that is located adjacent to, and/or connected to, the first side of the second portion and the third portion having a second side that is located adjacent to, and/or connected to, the second side of the second portion;
(ii) the third portion is disposed at or defines a second edge of the band;
(iii) the first and third portions are on opposite sides of the band, thereby defining opposite edges of the band;
(iv) the third portion and the second portion have different textures and/or strengths, thereby resulting in the third and second portion having the different amounts of at least one of: stretchiness, flexibility and elasticity;
(v) the third portion includes at least one of: plastic, rubber, silicone; addition cure silicone elastomer; a sturdy rubber, a sturdy silicone and a sturdy addition cure silicone elastomer;
(vi) the third portion and the second portion have different thicknesses, thereby resulting in the first and second portion having the different amounts of at least one of: stretchiness, flexibility and elasticity, or the third portion and the second portion have the same or substantially the same thicknesses while the third and second portions have the different amounts of at least one of: stretchiness, flexibility and elasticity;
(vii) the third portion and the first portion have different thicknesses, thereby resulting in the third and first portions having different amounts of at least one of: stretchiness, flexibility and elasticity, or the third and first portions have the same or substantially the same thicknesses while the third and first portions have the different amounts of at least one of: stretchiness, flexibility and elasticity;
(viii) the third portion and the first portion have substantially the same or the same thicknesses, textures and/or strengths while the third and the first portions have the same amount of at least one of: stretchiness, flexibility and elasticity;
(ix) at least one of: the second portion has more at least one of stretchiness, flexibility and elasticity than the first portion and the third portion, and the third and first portions are at least one of harder and firmer than the second portion;
(x) the third portion has at least one of: about 5% less stretch than the second portion, about 10% less stretch than the second portion, about 15% less stretch than the second portion, about 20% less stretch than the second portion, and about 15% to about 20% less stretch than the second portion;
(xi) the third portion is integral with the second portion and the first portion;
(xii) the third portion is melded, merged, fused, melted, and/or blended together with the second portion;
(xiii) the second and third portions are at least one of co-linear, substantially co-linear, co-planar, substantially co-planar, co-axial and substantially co-axial;
(xiv) the third portion is thicker than the second portion, thereby resulting in the third and second portions having the different amounts of at least one of: stretchiness, flexibility and elasticity;
(xv) when the third and second portions have different thicknesses, the difference in thickness between the third portion and the second portion defines a rim or curved edge that operates to at least one of improve the grip of and secure the band onto the predetermined item; and
(xvi) the thickness of the third portion at least one of tapers and increases gradually over the width of the third portion as the third portion extends away from the second portion.

8. The grip aid device of claim 7, wherein at least one of:
(i) the third portion has a width that is at least one of: about 10.0 mm, about 12.0 mm, about 8.6 mm, about 12.5 mm, about 9.5 mm to about 15.5 mm, and about 6 mm; and
(ii) the third portion has a thickness that is at least one of: about 2.0 mm, about 4.0 mm, about 4.5 mm, about 4.0 mm to about 4.5 mm, about 4.2 mm, about 4 mm to about 4.4 mm, about 9.0 mm, about double the thickness of the second portion, and about double the thickness of any portion of the band.

9. The grip aid device of claim 8, wherein at least one of:
(i) at least one of the first and third portions include one or more structural features that operate to permit greater stretch or flex of the band as compared to the band not using the one or more structural features;
(ii) the one or more structural features include at least one of: one or more sloped surfaces, one or more tapered surfaces, one or more chamfered surfaces, one or more curved surfaces, one or more smooth surfaces, and one or more recesses or grooves;
(iii) at least one of the first and third portions is about 1.9 mm in width at its narrowest location when including the one or more structural features;
(iv) the one or more tapered surfaces, the one or more chamfered surfaces and the one or more angled surfaces have a 15 degree angle with respect to the surface of the band;
(v) at least one of the first and third portions include a curved end disposed adjacent to the second portion such that the band provides a comfortable grip and operates to at least one of stretch and flex up to 50% of the size of the band when the band is not being at least one of stretched and flexed;
(vi) at least one of the first and third portions differ from each other in at least one of length, width and thickness to permit greater stretch or flex of the band;
(vii) at least one of the first portion and the third portion includes an edge, the edge having a thickness larger than the thickness of the second portion; and
(viii) the edge of at least the one of the first portion and the third portion includes the one or more structural features.

10. The grip aid device of claim 9, wherein at least one of:
(i) at least one of the first portion and the third portion further includes a first section and a second section where the first section has a thickness that increases over the width thereof and the second section has a thickness that remains constant or substantially constant over the width thereof;
(ii) the first section has the same or substantially the same thickness as the second portion along the length of the first section that is adjacent to, and contacts or connects with, the second portion, and the thickness of the first section at least one of increases and tapers as the first section extends away from the second portion of the band;
(iii) the second section has a thickness that is the same or substantially the same as at least one of the thickest part of the first section and the portion of the first section that is adjacent to, and contacts or connects with, the second section;
(iv) the first section has a width that is at least one of: about 5.16 mm and about 2.16 mm to about 8.16 mm;
(v) the second section has a width that is at least one of: about 7.34 mm and about 4.34 mm to about 10.34 mm; and
(vi) the diameter from the curved end on one side of the grip aid device to the curved end on the other side of the grip aid device is at least one of: about 195 mm, about 190.5 mm, and about 190 mm to about 195 mm.

11. The grip aid device of claim 10, wherein at least one of:
(i) a portion of the band further includes liquid rubber or liquid silicone;
(ii) the liquid rubber or liquid silicone operates to be thinned or thickened with rubber or silicone thinner or with rubber or silicone thickener, respectively; and
(iii) one or more portions of the band cure at about 73 degrees Fahrenheit or 23 degrees Celsius with negligible to no shrinkage.

12. The grip aid device of claim 11, wherein at least one of:
(i) the band includes at least one of one or more etchings, one or more designs and one or more messages;
(ii) the at least one of one or more etchings, one or more designs and one or more messages comprises at least one of: one or more different textures, text, one or more graphical designs, one or more colors, one or more patterns, one or more different widths, one or more attached embellishments, one or more finishes, and one or more appliqués;
(iii) at least one of the plastic, the rubber, the silicone, the addition cure silicone elastomer, the sturdy rubber, the sturdy silicone and the sturdy addition cure silicone elastomer of the band is transparent or translucent such that the at least one of the one or more etchings, the one or more designs and the one or more messages of the band are viewable through the material of the band;
(iv) the band operates to glow in the dark or low light; and
(v) the band includes one or more fragrances such that the grip aid device operates as an air freshener.

13. The grip aid device of claim 12, wherein when the predetermined item has a first edge and a second edge, the first edge being disposed or located closer to the center of the predetermined item as compared to the second edge of the predetermined item located or disposed further away from the center of the predetermined item, at least one of:
(a) at least one of the first portion and the third portion of the grip aid device operates to at least one of:
(i) grip the first edge;
(ii) grip a predetermined circumference or line that is closer to the center of the predetermined item than another predetermined circumference or line of the predetermined item; and
(iii) grip a first side of the predetermined item; and
(b) the second portion of the grip aid device operates to at least one of:
(i) grip the second edge;
(ii) grip the other predetermined circumference or line; and
(iii) grip a second side of the predetermined item, the second side being located on the opposite side of the predetermined item from the first side.

14. A method of making a grip aid device, comprising:
(i) providing a mold including at least two injection ports disposed at predetermined positions in the mold;
(ii) injecting a predetermined amount of at least one of a first rubber, a first plastic and a first silicone into the mold in the first injection port of the at least two injection ports of the mold;
(iii) mounting the mold on a vulcanizer heated to a predetermined temperature;
(iv) waiting for a predetermined amount of time until the at least one of the first rubber, the first plastic and the first silicone in the mold is about half vulcanized or is semi-cured;
(v) injecting a predetermined amount of at least one of a second rubber, a second plastic and a second silicone into the mold in the second injection port of the at least two injection ports of the mold; and
(vi) removing the grip aid device from the mold once the at least one of the first rubber, the first plastic and the first silicone and the at least one of the second rubber, the second plastic and the second silicone have adhered to each other, thereby forming the grip aid device.

15. The method of claim 14, wherein at least one of:
(i) the at least one of the first rubber, the first plastic and the first silicone and the at least one of the second rubber, the second plastic and the second silicone are the same type or composition of material or are different types or compositions of material;
(ii) the at least one of the first rubber, the first plastic and the first silicone flows into a mid-stream level in the mold;
(iii) the at least one of the second rubber, the second plastic and the second silicone flows into its predetermined mold level;
(iv) both injection steps occur at the same time in a single injection process;
(v) the injection steps occur at different times in a double injection process;
(vi) the predetermined temperature is at least one of: 120 degrees Fahrenheit, 120 degrees Celsius and a temperature corresponding to the weight of the at least one of the rubber, plastic and silicone being molded;
(vii) the predetermined amount of time is about five minutes;
(viii) the at least one of the first rubber, the first plastic and the first silicone in the mold is about half vulcanized or is semi-cured when the at least one of the first rubber, the first plastic and the first silicone in the mold is no longer liquid; and
(ix) the at least two injection ports comprise two injection ports.

16. The method of claim 15, wherein the at least two injection ports disposed at predetermined positions in the mold comprise three injection ports.

17. The method of claim 16, further comprising:
(i) waiting for the predetermined amount of time until the at least one of the first rubber, the first plastic and the first silicone is fully cured, and the at least one of the second rubber, the second plastic and the second silicone is semi-vulcanized and, due to a common curing process, the at least one of the first rubber, the first plastic and the first silicone and the at least one of the second rubber, the second plastic and the second silicone have been firmly bonded together;
(ii) injecting a predetermined amount of at least one of a third rubber, a third plastic and a third silicone into the mold in the third injection port of the three injection ports of the mold;
(iii) waiting for a second predetermined amount of time until the curing of the at least one of the first rubber, the first plastic and the first silicone, the at least one of the second rubber, the second plastic and the second silicone and the at least one of the third rubber, the third plastic and the third silicone is complete; and
(iv) removing the grip aid device from the mold once the at least one of the first rubber, the first plastic and the first silicone, the at least one of the second rubber, the second plastic and the second silicone and the at least one of the third rubber, the third plastic and the third silicone have adhered to each other, thereby forming the grip aid device.

18. The method of claim 17, wherein at least one of:
(i) the injection ports are cut off from the grip aid device;
(ii) the at least one of the first rubber, the first plastic and the first silicone, the at least one of the second rubber, the second plastic and the second silicone and the at least one of the third rubber, the third plastic and the third silicone are the same type or composition of material or are different types or compositions of materials;
(iii) the predetermined levels for each of the at least one of the first rubber, the first plastic and the first silicone, the at least one of the second rubber, the second plastic and the second silicone and the at least one of the third rubber, the third plastic and the third silicone are the same or different;
(iv) the at least one of the first rubber, the first plastic and the first silicone and the at least one of the third rubber, the third plastic and the third silicone are the same type or composition of material, and the at least one of the second rubber, the second plastic and the second silicone is a different type or composition of material;
(v) the three injection ports are disposed at predetermined, corresponding positions along the length of the mold; and
(vi) the second predetermined amount of time is about 10 minutes.

19. The method of claim 18, further comprising at least one of:
(i) using a round or substantially round mold with a thickness of approximately 4 mm in thickness and about 10 inches in diameter;
(ii) using a circular or round pan to achieve the desired round shape so the mold, which is made out of a silicone, plastic or rubber material, operates to be poured inside the circle of the circular or round pan and around it;
(iii) leaving the mold to dry for about 12 hours;
(iv) removing the circular or round pan after the mold is dry, thereby leaving the space empty to pour the first, second and/or third at least one of the rubber, the plastic and the silicone material into the circular or round pan;
(v) leaving the first, second and/or third at least one of the rubber, the plastic and the silicone material to dry for about 12 hours;
(vi) removing the mold after the first, second and/or third at least one of the rubber, the plastic and the silicone material is dry, thereby getting a substantially round grip aid device;
(vii) using vacuum degassing to minimize and/or reduce air bubbles in the cured grip aid device;
(viii) using a liquid rubber or liquid silicone as one of the first, second and/or third at least one of the rubber, the plastic and the silicone material;
(ix) thinning or thickening the liquid rubber or liquid silicone with a rubber or silicone thinner or with a rubber or silicone thickener, respectively; and
(x) curing one or more portions of the grip aid device at about 73 degrees Fahrenheit or 23 degrees Celsius such that the grip aid device has negligible to no shrinkage.

20. The method of claim 19, further comprising using gravity to have the at least one of the first rubber, the first plastic and the first silicone and the at least one of the second rubber, the second plastic and the second silicone flow into predetermined first and second mold levels, respectively, in the mold.
